(19) United States
(12) Patent Application Publication
(10) Pub. No.: US 2025/0173737 A1
(43) Pub. Date: May 29, 2025

(54) DATA MANAGEMENT SYSTEMS AND METHODS FOR ASSET TOKENIZATION, BLOCKCHAIN-BASED VERIFICATION, AND INTRINSIC VALUATION

(71) Applicant: STEEL American Luxury, LLC, Winnetka, IL (US)

(72) Inventor: Nicole Steel, Winnetka, IL (US)

(73) Assignee: STEEL American Luxury, LLC, Winnetka, IL (US)

(21) Appl. No.: 19/041,739

(22) Filed: Jan. 30, 2025

Related U.S. Application Data
(63) Continuation-in-part of application No. 18/733,600, filed on Jun. 4, 2024.
Application No. 18/733,600 is a division of application No. 18/525,661, filed on Nov. 30, 2023, now Pat. No. 12,026,720.
(60) Provisional application No. 63/428,889, filed on Nov. 30, 2022.

(51) Int. Cl. G06Q 30/018; G06Q 40/08; H04L 9/00; H04L 9/40

(52) U.S. Cl. CPC G06Q 30/018; G06Q 40/08; H04L 63/0807; H04L 9/50

(57) ABSTRACT

A device may at least one computing device associated with at least one blockchain platform, said at least one computing device having on-chain storage for maintaining a local copy of at least one distributed ledger that records transactions relating to said RWA. A device may at least one application program associated with the at least one blockchain platform, said at least one application program configured to: receive initial state information associated with the RWA that has been captured by at least one data collection device, record on the at least one distributed ledger an initial RWA state transaction which correlates said initial state information to said RWA, receive information identifying an initial custodian of said RWA, record on the at least one distributed ledger an initial RWA custody transaction which correlates said initial custodian to said RWA; and create an initial RWA token for the initial custodian which can be circulated on said at least one blockchain platform, wherein said initial RWA token reflects the initial state information.

### CROSS-REFERENCE TO RELATED APPLICATION

This application is a continuation-in-part of U.S. patent application Ser. No. 18/733,600, filed Jun. 4, 2024, which claims priority to U.S. Patent No. 12,026,720, filed Nov. 30, 2023. U.S. Pat. No. 12,026,720 claims priority to U.S. Provisional Application 63/428,889 filed on Nov. 30, 2022. Each of these prior applications are incorporated by reference herein in their entireties.

### TECHNICAL FIELD

This disclosure generally relates to blockchain technology and, more specifically, to systems and methods for blockchain-based verification and authentication of real-world assets (RWAs). The disclosure further relates to systems and methods for establishing the intrinsic value of RWAs through multi-faceted verification processes, enabling their tokenization into digital representations that serve as the foundation for structured financial products.

### BACKGROUND

The development of blockchain technology has enabled unprecedented advancements in asset management, authentication, and tracking. Traditionally, brands and organizations have used distributed ledger technology (DLT) to track the provenance of products and materials throughout their lifecycle. For example, many brands have partnered with distributed ledger technology to track the provenance of products and materials from manufacture to delivery. Using distributed ledgers (e.g., blockchains), brands can digitize, track, and trace the entire lifecycle of assets, such as a luxury item. With blockchain, brands can create an immutable record of all steps in the supply chain, capture specific data points, such as sustainability certifications and claims, and provide open access to this data publicly. This traceability is also leveraged when using blockchains to support supply chains. Blockchain can greatly improve supply chains by enabling faster and more cost-efficient delivery of products, enhancing products' traceability, improving coordination between partners, and aiding access to financing. Using DLT (e.g., blockchain), it is now possible to digitize, track, and trace real-world assets (RWAs) across diverse industries, including commodities, institutional real estate, luxury goods, and collectibles.

However, despite these advancements, current systems lack a comprehensive framework for verifying the intrinsic value of RWAs and enabling their tokenization into Digital Asset-Backed Securities (DABSs). These tokenized assets not only facilitate fractional ownership and increased liquidity but also allow for the creation of structured financial products, such as derivatives, ESG-linked bonds, and asset-backed securities. Such structured products have the potential to redefine financial markets by creating a new asset class based on intrinsic value, compliance, and programmability. The present disclosure is aimed at addressing these unresolved needs.

### SUMMARY

The present disclosure provides systems and methods for blockchain-based authentication, tokenization, and lifecycle management of real-world assets (RWAs). Leveraging the traceability, transparency, and immutability of distributed ledger technology, this technology facilitates the authentication, ownership, and intrinsic value verification of RWAs, transforming them into tokenized representations. These systems enable the creation and trading of Digital Asset-Backed Securities (DABSs), a novel financial instrument class that brings efficiency, transparency, and compliance to global financial markets.

Using DLT (e.g., blockchain), it is possible to digitize, track and trace real-world assets (RWAs) across diverse industries, including commodities, institutional real estate, luxury goods and collectables, to name a few. For commodities and institutional real estate, just as two representative examples, blockchain offers solutions to authenticate ownership, verify asset conditions, and ensure compliance across jurisdictions. This transparency enhances market efficiency and fosters trust among institutional investors, hedge funds, traders, and other market participants. By integrating smart contracts, stakeholders can program customized royalty distributions, gains allocation, and compliance protocols into these digital representations, ensuring all parties within the custody chain benefit from secondary market activity.

In the luxury goods, art, and collectibles sectors (among others), blockchain enables traceability, preventing counterfeiting and ensuring the authenticity of high-value items. This innovation extends to manufacturers, insurers, auditors, and custodians, offering new financial products and risk management tools that align with the growing demand for transparency and compliance.

As noted above, despite various advances utilizing blockchain ecosystems, current systems lack a comprehensive framework for verifying the intrinsic value of RWAs and enabling their tokenization into DBAs. The present disclosure provides a foundational infrastructure to address these challenges, offering an end-to-end solution for verifying, tokenizing, and trading RWAs across commodities, institutional real estate, luxury markets, and beyond. By creating programmable smart contracts tied to verified RWAs, this system ensures institutional-grade compliance, customizable royalties, and programmable gains distribution, revolutionizing how institutional investors, hedge funds, traders, and other market participants interact with tokenized assets.

The teachings herein generally relate to blockchain technology and, more specifically, to systems and methods for blockchain-based verification and authentication of real-world assets (RWAs). The teachings further relate to systems and methods for establishing the intrinsic value of RWAs through multi-faceted verification processes, including one or more data collection devices, such as an IoT device, AI, and satellite imaging, enabling their tokenization into digital representations. These tokenized representations serve as the foundation for structured financial products, referred to herein as Digital Asset-Backed Securities (DABSs). The disclosure enables the creation, verification, and lifecycle management of DABSs, leveraging a modular framework that integrates compliance, programmable royalties, atomic settlement, and ESG metrics to establish efficient, transparent, and compliant global financial markets. In that there is a lack of standardized financial instruments derived from tokenized RWAs and an inability to pool diverse commodities into a single tradable product, the teachings herein allow for the creation, for example, of a DABS index enabling pooled commodities to trade efficiently, as well as enhanced liquidity and price discovery for institutional traders.

Systems and methods are provided for blockchain-based asset authentication that leverages the traceability and immutability of distributed ledger technology to enable the authentication and ownership of assets. At times herein, the technology is discussed with particular reference to luxury goods, the raw materials used in their manufacture, and/or other items, collectibles, materials, products or goods in a manufacturing, building and/or supply chain. These assets can more generally be referred to as real-world assets (RWAs). RWAs, as referred to herein, encompass a wide array of assets, including but not limited to, commodities, institutional real estate, luxury goods, carbon credits, collectibles, raw materials, and manufacturing components. RWAs may be in finished or unfinished forms, or any component thereof at any stage of its lifecycle. This includes raw materials used in the manufacturing process, ensuring comprehensive applicability across supply chains, manufacturing, and global trade.

In fact, the term RWA even encompasses assets from any location and with any attributes, including commodities found in space for which there is no verifiable custody or valuation. One such example is Platinum-Group Metals (PGMs) mined from asteroids. There currently exist no financial instruments for such assets. In some aspects, the teachings herein allow for (1) tokenization through satellite imaging and IoT devices; (2) dynamic linking of tokens to asset extraction rates and quality; and (3) the enabling of futures markets tied to asteroid mining outputs. Thus, the present technology and its associated verification system enables the creation of new digital financial markets.

Another example might be a commodity such as organic corn from Iowa because there are currently no micro-market commodities for region-specific assets or the ability to hedge against specific crop risks (e.g., organic vs. inorganic corn) and take positions on supply demand and their derivatives and secondary markets. In this situation the present solution allows for (1) tokenized attributes such as USDA certification, farm location, and harvest quality; (2) real-time pricing via IoT and satellite monitoring; and (3) futures contracts tailored to these micro-markets to enable granular hedging.

Accordingly, the term RWA can relate to anything which has an intrinsic value which can be tokenized and therefore, should be understood to encompass any of the above types of assets/goods either in finished or unfinished product form, as well as any portion or component of the assets/goods at any stage during its life cycle, including any raw materials associated with them, which could benefit from the teachings herein, and irrespective of their location.

Tokenizing RWAs requires reliable mechanisms to establish intrinsic value, compliance and tradability. Current systems, however, lack robust frameworks for custody verification, lifecycle management and programmable gains distribution. The present technology addresses these deficiencies by providing blockchain-based asset RWA authentication methods and systems to support intrinsic value verification of RWAs and the tokenization of RWAs which can be used to create structured financial products for the RWAs that can be globally traded and ultimately liquidated as desired. Stated more generally, systems and methods are contemplated for verifying, tokenizing and originating structured financial products for RWAs. The disclosed technology provides a comprehensive solution through a multi-layered approach that combines IoT, AI, and blockchain to verify custody chains, lifecycle data, and intrinsic value. Smart contracts enable programmable royalties, lifecycle management, and gains distribution, further facilitating compliant tokenization and secondary market trading.

Novel aspects of the present disclosure include one or more of the following:
Verification Framework: Multi-layered verification using manual processes, automation processes, IoT devices, satellite imaging, and/or AI.
Tokenization Process: Dynamic tokens representing intrinsic value, fractional ownership, and compliance data.
Structured Financial Products: Derivatives, ESG-linked bonds, DABSs, pooled ETFs, and indices derived from tokenized RWAs.
Secondary Markets: Atomic settlement, cross-chain interoperability, and programmable royalties ensure efficient and equitable trading.
Government Infrastructure: Tokenization of public projects and municipal bonds for efficient capital raising.
Off-Planet Resources: Inclusion of asteroid-mined metals and other extraterrestrial assets.
Dynamic Adjustments: Tokens dynamically reflect market changes, ESG metrics, or other real-world attributes.

These and other aspects of the disclosed technology provide the foundation for a scalable and compliant digital financial ecosystem, redefining how RWAs are managed, traded, and valued.

In one example use case, a digital passport associated with an RWA enables the owner to track its provenance and condition, supporting long-term investment decisions. This transparency promotes sustainability, traceability, and compliance throughout the lifecycle of the asset. Additionally, the sourcing and manufacturing processes benefit from the immutable records provided by blockchain, ensuring greater accountability and efficiency in global supply chains.

The disclosed systems and methods address critical gaps in current technologies, such as the lack of robust custody chain verification, lifecycle management, and programmable gains distribution. By enabling intrinsic value verification and compliant tokenization, an infrastructure is enabled for an efficient, transparent, and scalable digital financial market, positioning DABSs as a transformative asset class for institutional investors, traders, manufacturers, auditors, insurers, and custodians.

In short, the present disclosure provides a framework for authenticating, tokenizing, and trading RWAs, creating an ecosystem that empowers stakeholders across industries with efficiency, transparency, and compliance while unlocking unprecedented financial opportunities through DABSs. In this regard, the following features are provided herein:

Clause 1. A data management system for a real world asset (RWA), comprising: at least one computing device associated with at least one blockchain platform, said at least one computing device having on-chain storage for maintaining a local copy of at least one distributed ledger that records transactions relating to said RWA; and at least one application program associated with the at least one blockchain platform, said at least one application program configured to: receive initial state information associated with the RWA that has been captured by at least one data collection device; record on the at least one distributed ledger an initial RWA state transaction which correlates said initial state information to said RWA; receive information identifying an initial custodian of said RWA; record on the at least one distributed ledger an initial RWA custody transaction which correlates said initial custodian to said RWA; and create an initial RWA token for the initial custodian which can be circulated on said at least one blockchain platform, wherein said initial RWA token reflects the initial state information.

Clause 2. The data management system of clause 1 wherein said at least one application program is further configured to create a structured financial product that is derived from said RWA.

Clause 3. The data management system of clause 2 wherein said structured financial product is one of a derivative, an ESG-linked bonds, a digital asset backed security (DABS), or a pooled ETF.

Clause 4. The data management system of clause 1 wherein said initial RWA token is dynamically connected to said RWA.

Clause 5. The data management system of clause 1 wherein said initial RWA token is disconnected from said RWA.

Clause 6. The data management system of clause 1 wherein said at least one application program is further configured to create an initial digital passport for display on a user device, wherein said initial digital passport verifies the initial custodian of said RWA and said initial state information.

Clause 7. The data management system of clause 1 wherein said initial state information corresponds to at least one of a condition of said RWA or a location of said RWA.

Clause 8. The data management system of clause 1 wherein said at least one application program is further configured to receive, from the at least one data collection device, subsequent state information associated with said RWA, and record on the at least one distributed ledger a subsequent RWA state transaction which correlates said subsequent state information to said RWA.

Clause 9. The data management system of clause 8 wherein said subsequent state information corresponds to at least one of a change in condition of said RWA or a change in location of said RWA.

Clause 10. The data management system of clause 9 wherein said at least one application program is further configured to receive information corresponding to a subsequent custodian of said RWA and record on the at least one distributed ledger a subsequent custody transaction which correlates said subsequent custodian to said RWA.

Clause 11. The data management system of clause 8 wherein said at least one application program is further configured create a subsequent RWA token for circulation on said at least one blockchain platform, wherein said subsequent RWA token reflects the subsequent state information.

Clause 12. The data management system of clause 11 wherein said at least one application program is further configured to selectively decommission said initial RWA token.

Clause 13. The data management system of clause 1 wherein said at least one application program is further configured to receive information corresponding to a subsequent custodian of said RWA and record on the at least one distributed ledger a subsequent custody transaction which correlates said subsequent custodian to said RWA.

Clause 14. The data management system of clause 1 wherein said at least one application program is further configured to interact with one or more smart contracts on the at least one blockchain platform to periodically validate regulatory compliance of said RWA, update said initial RWA token, and control circulation of said initial RWA token based on jurisdictional or contractual criteria.

Clause 15. The data management system of clause 1 wherein said at least one application program is further configured to interact with one or more smart contracts on the at least one blockchain platform to distribute a programmable royalty to an original owner of said RWA in response to a transfer of ownership of said initial RWA token.

Clause 16. The data management system of clause 15 wherein said at least one application program is further configured to interact with said one or more smart contracts to distribute a respective programmable royalty to the original owner of said RWA in response to a transfer of ownership of each subsequent RWA token.

Clause 17. The data management system of clause 1 wherein said at least one application program is further configured to interact with one or more smart contracts on the at least one blockchain platform to fractionalize ownership rights in said initial RWA token.

Clause 18. The data management system of clause 1 wherein said at least one application program is further configured to interact with one or more smart contracts on the at least one blockchain platform to link ESG metrics to said initial RWA token.

Clause 19. The data management system of clause 1 wherein said initial RWA token is configured for cross-chain circulation among multiple blockchain platforms.

Clause 20. The data management system of clause 1 further comprising at least one off-chain storage device for storing additional information associated with said RWA.

Clause 21. The data management system of clause 1 wherein the initial state information corresponds to at least one of an initial physical condition of said RWA, an initial geolocation of said RWA, and an initial compliance status of said RWA.

Clause 22. A data management system for a real world asset (RWA), comprising: at least one data collection device for capturing initial state information associated with the RWA; at least one computing device associated with at least one blockchain platform, said at least one computing device having on-chain storage for maintaining a local copy of at least one distributed ledger that records transactions relating to said RWA; at least one user device; and at least one application program associated with the at least one blockchain platform, said at least one application program configured, in conjunction with said at least one data collection device, said at least one computing device and said at least one user device, to: receive the initial state information from said at least one data collection device; record on the at least one distributed ledger an initial RWA state transaction which correlates said initial state information to said RWA; receive information identifying an initial custodian of said RWA; record on the at least one distributed ledger an initial RWA custody transaction which correlates said initial custodian to said RWA; and create an initial RWA token for circulation on said at least one blockchain platform.

Clause 23. The data management system of clause 22 wherein said at least one data collection device is configured to capture initial state information corresponding to at least one of an initial physical condition of said RWA, an initial geolocation of said RWA and an initial compliance status of said RWA.

Clause 24. The data management system of clause 22 wherein said at least one data collection device comprises at least one of an IoT device, an imaging device and an AI device.

Clause 25. The data management system of clause 22 wherein said at least one application program is further configured to create a structured financial product that is derived from said RWA.

Clause 26. The data management system of clause 25 wherein said structured financial product is one of a derivative, an ESG-linked bonds, a digital asset backed security (DABS), or a pooled ETF.

Clause 27. The data management system of clause 22 wherein said initial RWA token is dynamically connected to said RWA.

Clause 28. The data management system of clause 22 wherein said initial RWA token is disconnected from said RWA.

Clause 29. A data management method for a real world asset (RWA), comprising: receiving, from at least one data collection device, initial state information associated with the RWA that has been captured by the at least one data collection device; sending to at least one distributed ledger of at least one blockchain platform an initial RWA state transaction which correlates said initial state information to said RWA; receiving information identifying an initial custodian of said RWA; sending to the at least one distributed ledger an initial RWA custody transaction which correlates said initial custodian to said RWA; and creating an initial RWA token for the initial custodian which can be circulated on said at least one blockchain platform, wherein said initial RWA token reflect the initial state information.

Clause 30. The data management method of clause 29 further comprising creating an initial digital passport for display on a user device, wherein said initial digital passport verifies the initial custodian of said RWA and said initial state information.

Clause 31. The data management method of clause 29 further comprising receiving from the at least one data collection device, subsequent state information associated with said RWA, and sending to the at least one distributed ledger a subsequent RWA state transaction which correlates said subsequent state information to said RWA.

Clause 32. The data management method of clause 31 further comprising receiving information corresponding to a subsequent custodian of said RWA and sending to the at least one distributed ledger a subsequent custody transaction which correlates said subsequent custodian to said RWA.

Clause 33. The data management method of clause 32 further comprising creating a subsequent RWA token for circulation on said at least one blockchain platform, wherein said subsequent RWA token reflects the subsequent state information.

Clause 34. The data management method of clause 33 further comprising selectively decommission said initial RWA token.

Clause 35. The data management method of clause 29 further comprising interacting with one or more smart contracts on the at least one blockchain platform to periodically validate regulatory compliance of said RWA, update said initial RWA token, and control circulation of said initial RWA token based on jurisdictional or contractual criteria.

Clause 36. The data management method of clause 29 further comprising interacting with one or more smart contracts on the at least one blockchain platform to distribute a programmable royalty to an original owner of said RWA in response to a transfer of ownership of said initial RWA token.

Clause 37. The data management method of clause 36 further comprising interacting with said one or more smart contracts to distribute a respective programmable royalty to the original owner of said RWA in response to a transfer of ownership of each subsequent RWA token.

Clause 38. The data management method of clause 29 further comprising interacting with one or more smart contracts on the at least one blockchain platform to fractionalize ownership rights in said initial RWA token.

Clause 39. The data management method of clause 29 further comprising creating a structured financial product that is derived from said RWA.

Clause 40. The data management method of clause 39 wherein said structured financial product is one of a derivative, an ESG-linked bonds, a digital asset backed security (DABS), or a pooled ETF.

Clause 41. The data management method of clause 29 wherein said initial RWA token is dynamically connected to said RWA.

Clause 42. The data management method of clause 29 wherein said initial RWA token is disconnected from said RWA.

### BRIEF DESCRIPTION OF THE DRAWINGS

The drawings and detailed description that follow are intended to be illustrative and are not intended to limit the scope of the invention as contemplated by the inventors.

FIG. 1 is a schematic diagram of an example system configured to digitally authenticate ownership of RWAs.

FIG. 2 is a flowchart of an example set of high-level operations that a system performs to digitally authenticate ownership of RWAs.

FIG. 3 is a screenshot of an example digital passport interface.

FIG. 4 is a screenshot of an example authentication interface.

FIG. 5 is a schematic diagram illustrating example information stored by public and private databases.

FIG. 6 is a schematic diagram illustrating an example processing system in which at least some operations described herein can be implemented.

FIG. 7 is a schematic diagram illustrating a process flow from manufacturing to resale in which each operation can leverage the described technology.

FIG. 8 is a schematic diagram illustrating the interactions between components of embodiments in accordance with the described technology.

FIGS. 9 is a flowchart of example methods for blockchain-based asset authentication.

FIG. 10 illustrates a representative system architecture that may be implemented in accordance with one or more aspects of the described technology to achieve the blockchain ecosystem described herein.

FIG. 11 is a flowchart of an example data management method for a RWA.

### DETAILED DESCRIPTION

As noted above, tokenizing RWAs requires reliable mechanisms to establish intrinsic value, compliance and tradability. Current systems, however, lack robust frameworks for custody verification, lifecycle management and programmable gains distribution. The present technology addresses these challenges by introducing a modular system that enables seamless tokenization and trading of RWAs, thus creating new financial markets for them. Thus, the technology supports the creation of structured financial products, synthetic financial products and secondary markets, laying the foundation for a scalable, global ecosystem for RWAs.

There are several significant challenges in authenticating the validity and provenance of the components of or the finished goods of RWAs such as real estate, consumer goods, collectibles (e.g. art, wine, and cars), high-end luxury items, such as jewelry, perfume, and clothing and their secondary markets that negatively impact vendors and consumers alike. Indeed any type of suitable item or asset might need to have its provenance and validity validated, so that the above listing is only representative of what a RWA can encompass. That said, the description at times will proceed with reference to a RWA in the form of a luxury good as a representative example only. However, the ordinarily skilled artisan will readily appreciate that the teachings herein can be applied to an of a variety of other RWAs in the form of goods, items or materials besides luxury goods. At times throughout the description, example references to other types of RWAs are provided.

While the quality of luxury goods, for example, is generally far above that of standard goods, the differences are often not immediately apparent from general inspection at the time of purchase. As a result, luxury goods are prone to targeting by counterfeiters seeking to produce reasonable counterfeits that may be sold at a steep discount from the actual luxury product, but at a price that is still far above the value of the counterfeit product.

Due to the value of luxury goods and cultural notoriety, they are also frequently targeted for opportunistic or organized theft. As an example, it is becoming increasingly common for a luxury good retail location's inventory to be mostly or entirely stolen by an organized group that simply enters the location's front door during business hours, seizes the goods, and then leaves before security or authorities can intervene. Such goods are then sold directly to buyers in person or using various online marketplaces, leaving buyers at risk for purchased goods later being seized or recovered and returned to the retailer. In certain cases, the counterfeits are made to resemble the original design and materials so closely, experts and corporate inspections are sometimes unable to flag all the counterfeit products and goods.

Since consumable goods and luxury products are produced and sold at relatively high volume, they tend to be fungible and generally indistinguishable from each other, which makes it very challenging to identify or trace counterfeit goods or goods that have been stolen. While manufacturers may incorporate serial numbers or authenticity markings or identifiers to goods, such physical markings are subject to tampering, alteration, or removal, and so provide an imperfect safeguard against counterfeiting and theft.

As disclosed herein, digital authentication provides a public or semi-public set of authentication records that link to particular manufactured products, and that may also link to particular owners or purchasers of those products. As an example, a luxury purse may be uniquely associated with a record of authenticity in a public blockchain at the time of manufacture and have an intrinsic value at this point.

A subsequent purchaser of the purse may then register the product and be uniquely associated with the product records stored in the blockchain, with the purchaser's personal information being associated with another intrinsic value and stored on the blockchain, in a private database linked to the blockchain records (or transactions), or both. In this manner, the owner of the purse, or a third party capable of accessing the blockchain, may verify the authenticity of the purse based on the blockchain records, which may be helpful in determining that the purse is not a counterfeit, in addition to learning other details such as the location and date of manufacture, materials used during manufacture, and other information. Similarly, the owner of the purse, or a third party capable of accessing the blockchain and/or private database, may verify ownership of the purse based on the blockchain and/or private database records. In certain aspects, implementations of the disclosed technology may issue and/or revoke digital passports to owners that register certain RWAs with the system, and such digital passports may be presented and/or transmitted by the owner to other parties or systems in order to verify RWA authenticity and ownership, or to direct inquirers to the corresponding public/private database records, for example.

Since digital authentication in this manner is much less susceptible to tampering, removal, or interference in the same manner that physical serial numbers or authenticity markings are, there is a very clear separation from counterfeit and or/stolen goods. While a counterfeit good may still be bought and sold, the purchaser will immediately realize that it is a counterfeit good when they are unable to register the product with the digital authentications system, and do not receive their digital passport. Similarly, products and goods may still be subject to theft, but such stolen goods will be identified as stolen prior to or during registration with the digital authentication system, and so the purchaser will immediately determine that the product has been stolen. In each case, a possessor of the product will be unable to present or transmit a digital passport authenticating the item and ownership, which makes the item far less desirable to a subsequent purchaser and allows a subsequent purchaser to quickly and easily determine that the product is likely a result of counterfeiting or theft.

Another example of luxury RWA which could be tokenized and have its intrinsic value determined, thereby benefiting from the teachings herein, are diamonds which can be tokenized with verifiable attributes. Consider a trader who invests in tokenized diamonds with metadata attributes such as a GIA certification based on cut and clarity, origin of the diamonds, and resale value. Statistical tools and variance models can be used to assess the reliability of future price movements based on historical market trends. Such statistical tools might include: (1) Monte Carlo simulations which evaluate the impact of price volatility, supply-demand dynamics, and ESG compliance premiums on portfolio returns, or (2) real-time feeds which provide updated metrics such as token liquidity, compliance scores and market sentiment. With the present solution, tokens with intrinsic values derived from these attributes reduce speculation and enable secondary market trading. Further, it is contemplated that such trades could be executed manually by humans or automatically by programming smart contracts with instructions for executing trades. Machine learning (ML) could also be integrated into the platform to develop and learn trading strategies to automate the process.

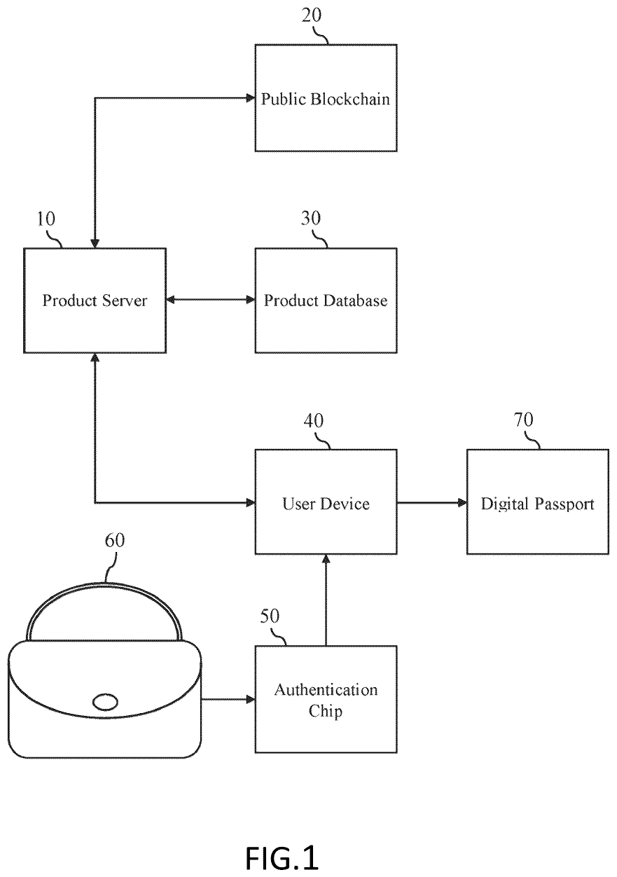

FIG. 1 is a schematic diagram illustrating one or more aspects of an example system configured to digitally authenticate ownership of RWAs, sometimes referred to herein as a Verification as a Service (VaaS) system, and the purpose of which is to verify the authenticity, custody and intrinsic value of RWAs. It should be appreciated that the intrinsic value of the RWA, whether its initial intrinsic value or a subsequent intrinsic value, can be based on one or more attributes of the RWA.

The intrinsic value of the RWA at any point in time can also be impacted by various weighted factors and statistical techniques which are used to derive the final, calculated intrinsic value of the token being analyzed or created at any particular point in time. That is, the value of the token can be derived based on the weighted sum of all identified factors 1 . . . n which contribute to its intrinsic value, wherein the weight reflects the importance or influence of a specific factor on the overall intrinsic value of the token. This intrinsic value can be reflected, for example, in metadata associated with the token. Understandably, certain factors might have a greater influence on the token's value relative to other factors, giving them greater weight in the calculation. These factors could include specific variables or attributes contributing to the token's intrinsic value and their standard deviation. Examples of such factors might include market demand for the RWA, underlying RWA market-to-market value, supply constraints, ESG (Environmental, Social and Governance) metrics, or any other measurable factor. Thus, the product of the weight of a factor and the value of that factor ensures that each factor contributes proportionally to its importance in the final intrinsic value calculation, and summing these weighted contributions across all factors gives the total intrinsic value of the token.

One benefit of intrinsically valuing RWAs is that this can be used to improve various hedging strategies. Doing so enables quantitative risk position justifications in that verifiable intrinsic value allows traders to back positions with data, and dynamic valuation models provide real-time metrics to justify alpha positions. In addition, existing hedging strategies often lack underlying data, whereas tokenized assets with verified attributes (e.g., purity, NOI) provide robust data sets for models. Existing hedging strategies can suffer from liquidity bottlenecks. Tokenized instruments provide liquidity by enabling fractional ownership (e.g., the distribution of divisible or shared financial interests in an asset) and secondary markets. Finally, existing hedging strategies have inefficient markets, whereas synthetic financial instruments build on verified DABS reduce inefficiencies by tying derivatives to real-world data.

With continued reference to FIG. 1, as shown therein, a product server (10) is in communication with a user device (40) and configured to provide interfaces and features usable by a user of the user device (40) to authenticate, review, and provide proof of ownership of a purchased product (60). The purchased product (60) includes an authentication chip (50), which may be affixed to a surface of the product or embedded within a portion of the product (60). The authentication chip may vary by product (60) and implementation, and may be, for example, a Radio Frequency Identification (RFID) tag, a Near Field Communication (NFC) tag, or other wirelessly communicating device that is capable of storing and exchanging data wirelessly with nearby devices such as the user device (40). More generally, the purchased product (60) includes an authentication mechanism that could include the authentication chip (50), an imaging device, an outward facing hologram sticker (a holographic sticker), and so on (and as will be further detailed later). In some implementations, the user device (40) may be a smart phone or other mobile computing device, while the authentication chip (50) may be an RFID or NFC tag, such that the user device (40) may communicate with the chip (50) while the chip is embedded within the material of the product (60).

As will be described in more detail below, when the user device (40) interacts with the chip (50), the user device (40) may be placed in communication with the product server (e.g., via a landing or registration page) to allow the user to complete the registration of their ownership of the product (60). The product server (10) may be configured to require various information from the owner during registration, which may include personal information, contact information, proof of purchase (e.g., photograph or digital documentation of a receipt or other sales document), and other information that may vary by implementation. The product server (10) is further configured to create and store records based upon products (60) relating to their manufacture and ownership, with different records being stored to a product database (30) (e.g., a private database accessible by the product server (10)) and blockchain (20) as will be described in more detail below. By storing such records across a combination of the product database (30) and blockchain (20), the disclosed technology takes advantage of the accessibility and immutability of records stored by the blockchain (20), for example, while preserving the privacy of an owner by storing potentially private information on the product database (30).

Once a product (60) is successfully registered, the product server (10) may provide a digital passport (70) to the user device (40) which may be stored by the user device (40), for example in digital Web3 wallet, and presented by the user in varying situations. The digital passport (70) may be, for example, a QR code or other encoded visual identifier, a unique signal or information that may be wirelessly communicated (e.g., an encoded data string that may be communicated via NFC, Bluetooth, or other wireless transmission, or presented as encoded audio, etc.). As will be described in more detail below, the digital passport (70) and related interfaces provided by the user device (40) may be presented to prove ownership of the product (60), provide information relating to the manufacture, source, and/or legal provenance of the product (60), gain access to exclusive events or other benefits, and for other purposes. As such, the digital passport provides secure and traceable ownership records pertaining to the lifecycle of the good.

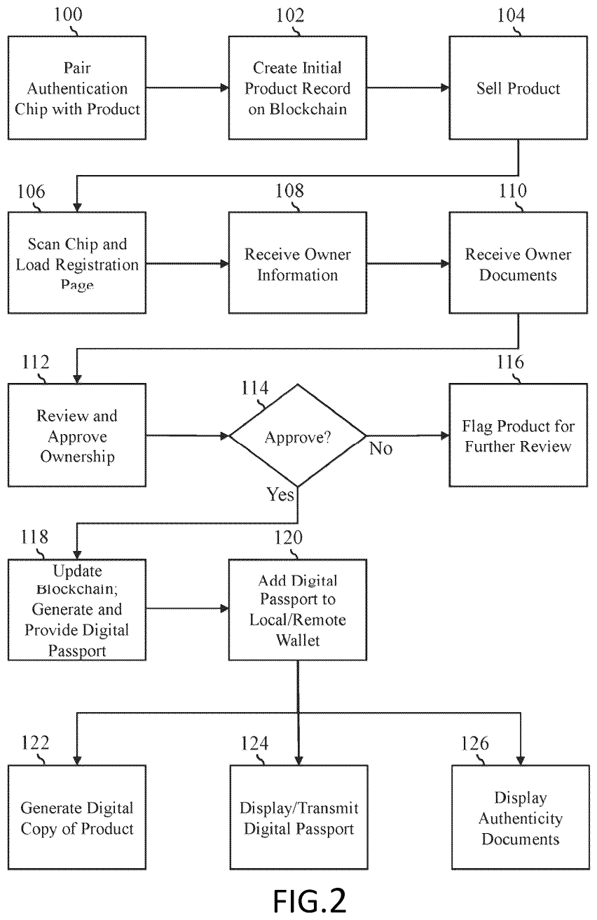

FIG. 2 is a flowchart of an example set of high-level steps that a VaaS system may perform to digitally authenticate ownership of RWAs. A system configured to perform steps such as those shown in FIG. 2 provides a user with proof of authenticity and provenance which is registered/tied to the blockchain as well as access to exclusive community features and events (e.g., such as an owners-only social media or communication platform that is only for holders of a digital passport (70)). As products (60) are manufactured and offered for sale, the corresponding authentication chip (50) embedded in each product (60) may configured to be paired (100) with the product (60) so that they are uniquely linked, which may also include writing (102) an initial record to the blockchain (20) to uniquely associate the product (60) with the authentication chip (50) (e.g., by serial number or other unique identifier). After initial registration, the product may be sold (104) to a purchaser.

When a purchaser uses a user device (40) to scan the authentication chip (50) that is embedded in or attached to their purchased product (60), the received information will cause the user device (40) to load (106) a registration page (e.g., such as by opening a web browser and loading a unique web location based on the received information, or by opening another mobile application). The system may receive (108) various owner information via the loaded (106) registration page, which may include an owner's identifying information such as name, location, email address, phone number, and other information. The system may also receive (110) various owner documents via the loaded (106) registration page, which may include photographs of receipts or other proof of purchase of the product (60), photographs of shipping or delivery confirmations, photographs of customs or importation documents, and other information. Received (108, 110) information may be stored on public databases (20), private databases (30), or both, and in varying implementations, private information that identifies the owner may be stored on private databases (30) while anonymous information of public concern (e.g., such as proof of importation, legal provenance, manufacturing data, materials of manufacture, etc.) may be stored on blockchains (20) so that it is publicly available to authenticate the product and/or ownership.

Once owner information (108, 110) is received, a software process may automatically validate ownership by comparing the provided (108, 110) information to transaction records available to the system. In some implementations, such review (112) and approval of ownership may be performed automatically, manually, or both (e.g., both a software process and a manual human review of information and documentation may be performed to approve ownership). Where ownership cannot be approved (114) (e.g., such as due to the product already being associated with an owners, or mismatch of product information with owner information due to error or intentional tampering), the system may flag (116) the attempted product registration for further review, which may require updating stored records or reconfiguration an authentication chip (50), or may require that ownership of the product by a previous owner be updated to reflect ownership by a new owner (e.g., such as resulting by a private sale or transfer of the product as a gift).

Where ownership can be approved (114), the system may update (118) the blockchain (20) to reflect that the product is now owned by an authenticated owner and may automatically generate and provide to the user device or user (e.g., using their provided contact information) a unique digital passport. As described, a digital passport (70) may be an encoded visual indicator, encoded data string for wireless transmission, or other signal or condition that may be presented via a user device's features or capabilities. The digital passport may be received by the user device and added (120) to a local or remote digital wallet associated with the user device. Addition (120) of the passport to a digital wallet (e.g., a Web3 wallet) associated with the user device may be performed automatically via a web browser or other mobile application during registration or may be performed as a result of single click or other simple operation. Once added (120) to a digital wallet, the digital passport may be stored and accessed by the user as needed and for various purposes. In some implementations, the product server (10) may be configured to issue and revoke digital passports, such as may be necessary when a digital passport is issued to a first owner of a product, and such product is subsequently transferred to and registered by a subsequent owner.

While a valid digital passport is stored on a user device, the user may use the passport to receive various benefits or exclusive features associated with ownership of the product. As an example, this may include using the digital passport to prove ownership and generate (122) or receive a digital copy of the product, such as through a tokenization process, that corresponds to the product itself (e.g., such as may be imported into, registered with, or used with various virtual reality, augmented reality, or standard virtual environments, games, or platforms). In this manner, a holder of the digital passport may be able to generate (122) and receive digital copies of their corresponding product in various games or social networks.

As another example, the digital copy of the corresponding product may be limited to a single “digital twin” that enjoys the same traceability and exclusively of the original product, and can be used in digital environments, e.g., the metaverse, Second Life™, etc. In some cases, the RWA and its digital twin must have the same owner and must be transferred (e.g., sold on the secondary market) together. In other cases, the digital twin of the RWA may be transferred (e.g., either sold or rented) to a different person. In yet other cases, multiple digital twins may be generated as previously discussed. The tokenization of the RWA or its digital twin can occur as part of a Tokenization as a Service (TaaS) offering.

As another example, the user may display or transmit the digital passport, or a portion of part of the digital passport, in order to uniquely identify themselves as the owner of the corresponding product. This may be used to access certain special events (e.g., such as a party, concert, sporting event, or other real-world activity where the digital passport serves as the holder's ticket or key to enter the event) by displaying a QR code or other optical code, providing a wireless authentication transmission, or other similar communication of the digital passport. Other examples include using the digital passport (124) to access private social networks or communication channels, receive early access to online content or events, receive discounts on purchases of products or services, and other examples.

As another example, the holder of the digital passport may be able to display (126) authenticity documents associated with the corresponding product. This may include displaying proof of ownership, proof of authenticity, and other information. This may also include displaying proof of legality or legal provenance, such as where a certain product may contain or be manufactured from materials that are either legally restricted for ownership or important into certain countries, or where a certain product may be independently verified by a nongovernmental agency to verify that its materials were ethically sourced, and so on. As one example, where a certain product contains alligator skin or other naturally sourced materials that may be subject to importation/exportation laws or other legal restrictions, the displayed (126) documents may include descriptions of the materials that are included in the product, copies of importation documents, copies of legal documents or information proving their legality, and other similar documentation.

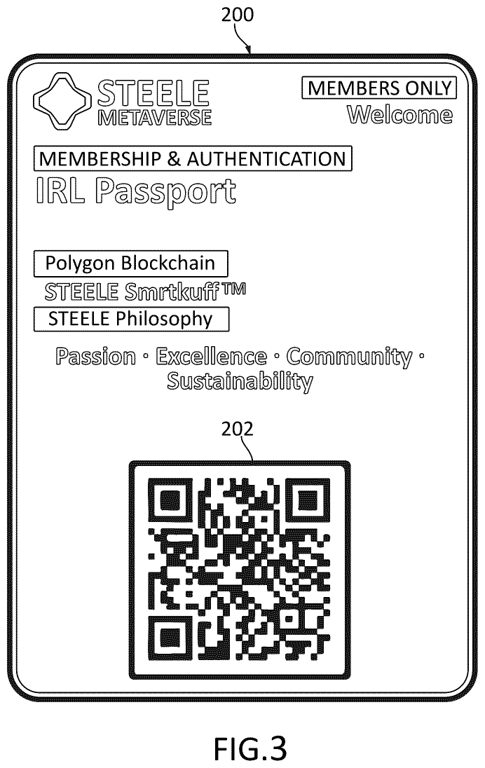

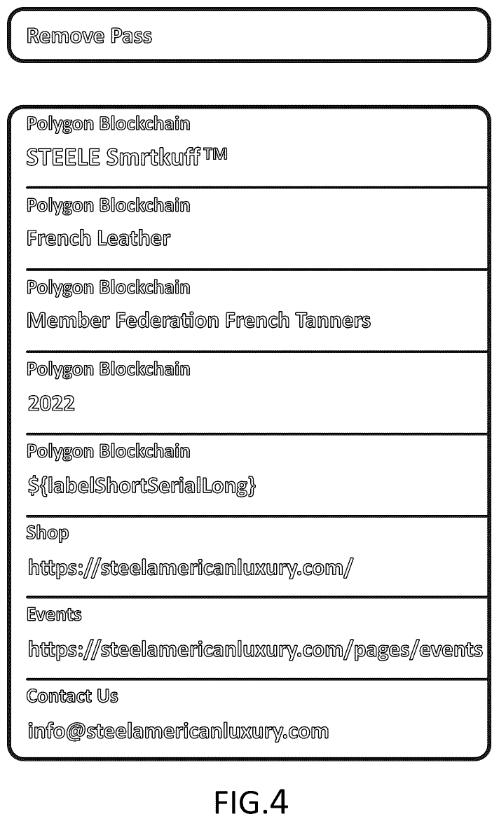

FIG. 3 is a screenshot of an example digital passport interface (200), which may also comprise part of the VaaS, such as might be presented when displaying (124, 126) passport or authenticity information. An optical code (202) is shown that may be uniquely generated for the owner and product at the time of registration, and that may serve as the owner's digital passport in some situations. FIG. 4 is a screenshot of an example authentication interface (204) that may be displayed by holders of a valid digital passport, and that may contain information from the blockchain (20), product database (30), or both. As depicted in FIG. 4, which may also comprise part of the VaaS, the interface (204) includes non-private information such as may be stored on the blockchain (20) and may be useful for public audit or review of product ownership and provenance.

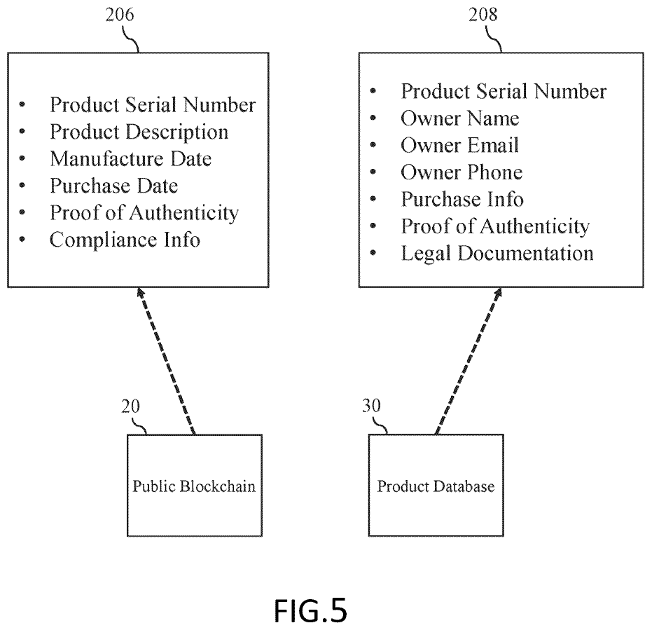

FIG. 5 is a schematic diagram illustrating example information stored by public and private databases, and which may also comprise part of the VaaS. The blockchain (20) and product database (30) may be configured to store public and private data, respectively, and may link such information together via a commonly shared primary key (e.g., product serial number). In this manner, members of the public that are familiar with the blockchain (20) may verify the existence, authenticity, and anonymous ownership of products by accessing the blockchain (20) directly (e.g., and avoiding the product server (10) entirely). In the same manner, owners of products or administrators of the product server (10) may combine records from the product database (30) with publicly available records to provide a complete picture of ownership, which may be useful when attempting to trace ownership of a lost or stolen product, to update product ownership when a product is sold or otherwise transferred to a subsequent owner, and in other situations.

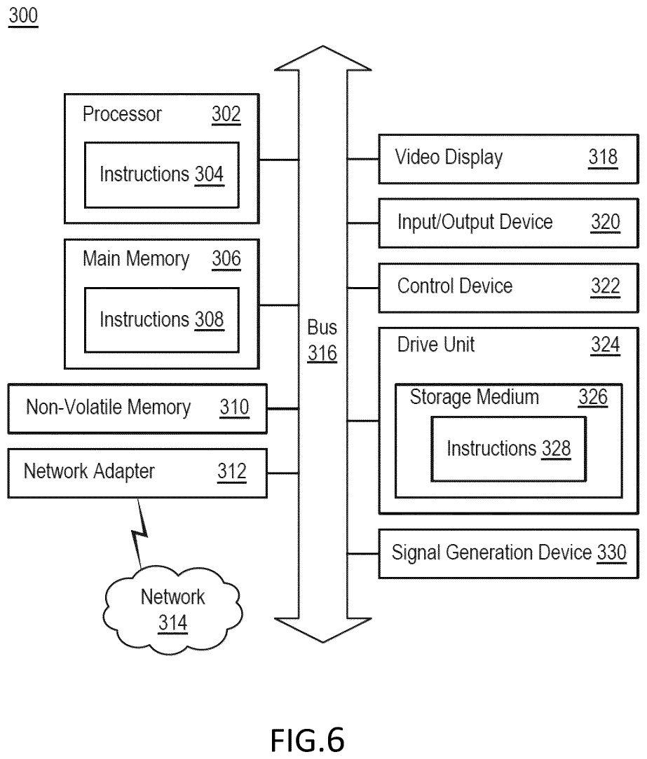

FIG. 6 is a schematic diagram illustrating an example processing system (300), which may also comprise part of the Vaas, in which at least some operations described herein can be implemented. For example, components of the processing system (300) may be hosted on a computing device using which an individual is able to interact with the blockchain-based tokenization system for data access and/or the web-based platform that accesses the web-facing segregated data storage (e.g., through interfaces presented via a computer program, such as a mobile application, desktop application, or web browser). As another example, components of the processing system (300) may be hosted on a computing device on which aspects of the described systems and platforms are implemented.

The processing system (300) may include any combination of a processor (302), main memory (306), non-volatile memory (310), network adapter (312), video display (318), input and output devices (320), control device (322) (e.g., a keyboard or pointing device), drive unit (324) including a storage medium (326), and signal generation device (330) that are communicatively connected to a bus (316). The bus (316) is illustrated as an abstraction that represents one or more physical buses or point-to-point connections that are connected by appropriate bridges, adapters, or controllers. The bus (316), therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I2C) bus, or an Institute of Electrical and Electronics Engineers (IEEE) standard 1394 bus (also referred to as “Firewire”).

While main memory (306), non-volatile memory (310), and storage medium (326) are shown to be a single medium, the terms “machine-readable medium” and “storage medium” should be taken to include a single medium or multiple media (e.g., a centralized/distributed database and/or associated caches and servers) that store one or more sets of instructions (328). The terms “machine-readable medium” and “storage medium” shall also be taken to include any medium that is capable of storing, encoding, or carrying a set of instructions for execution by the processing system (300).

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 304, 308, 328) set at various times in various memory and storage devices in a computing device. When read and executed by the processor (302), the instruction(s) cause the processing system (300) to perform operations to execute elements involving the various aspects of the present disclosure.

Further examples of machine-and computer-readable media include recordable-type media, such as volatile memory and non-volatile memory (310), removable disks, hard disk drives, and optical disks (e.g., Compact Disk Read-Only Memory (CD-ROMS) and Digital Versatile Disks (DVDs)), and transmission-type media, such as digital and analog communication links.

The network adapter (312) enables the processing system (300) to mediate data in a network (314) with an entity external to the processing system (300) through any communication protocol supported by the processing system (300) and the external entity. The network adapter (312) can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

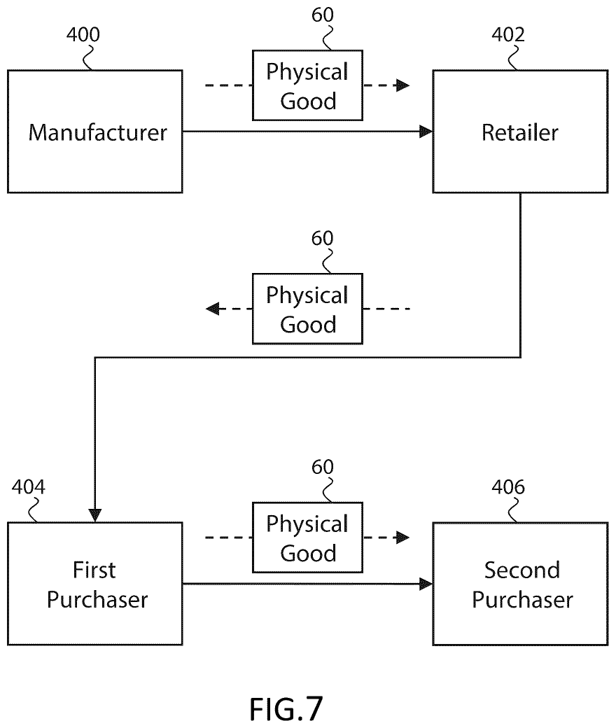

FIG. 7 is a schematic diagram illustrating a representative process flow from manufacturing to resale of a RWA (60) in which each operation can leverage the described embodiments. A manufacturer (400) can leverage the digital passport (e.g., as shown in FIG. 3) to provide (or, in an example, provide a link to) sourcing and environmental impact information that is associated with manufacturing the product. As discussed in the context of at least FIG. 2, this information in the digital passport will be available to each owner in the secondary market, thereby maintaining the provenance and manufacturing bona fides of the RWA (60). Similarly, and in another example, a subset of this information is made available in an authentication mechanism that uniquely identifies the RWA (60) and is configured to remain with the RWA (60) throughout its lifecycle. In yet another example, the manufacturer (400) can leverage the disclosed technology to authenticate the RWA (60), thereby preventing counterfeiting because any counterfeit products would not be able to access the digital passport.

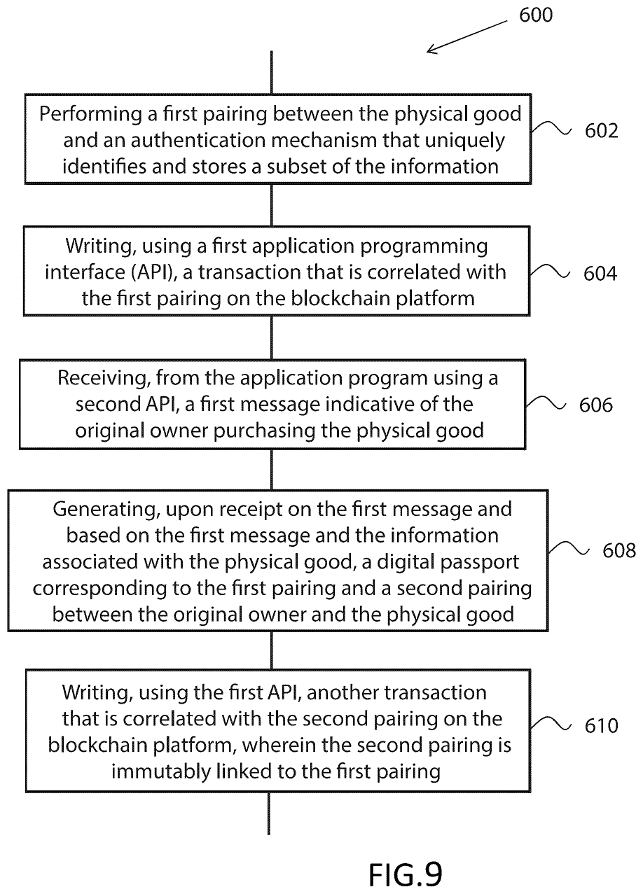

Similarly, a retailer (402) can leverage the disclosed embodiments to streamline the regulation and permitting process, thereby ensuring that the RWA (60) can get from the manufacturer (400) to the retailer (402) quickly (and further detailed in the context of FIG. 9B). Currently, the regulation and permitting process in the international trade of luxury goods (and even their raw materials) is subject to the whims of exporting and importing authorities. For example, a RWA (60) primarily made in Switzerland, which is to be sold in Paris, requires a Swiss export permit and a French import permit. However, each of the permitting authorities operate fairly independently, and due to permits and inspections required, do so on their own timelines. The exporting country (e.g., Switzerland) might require two days, whereas the importing country (e.g., France) may take multiple weeks to process the paperwork. As another example, in France, a governmental agency must validate that an item meets specifications before calling it haute joaillerie. (literally, “high jewelry”). With the digital passport and the pairing between the RWA (60) and the manufacturer (400) being correlated with a transaction written to the blockchain, the importing and exporting authorities will have real-time access to the same digital information, which is likely to significantly speed up the permitting and inspection process. In addition, the disclosed technology will provide wholistic supply chain transparency for the consumer while solving non-governmental organization (NGO) and government processes and inefficiencies globally, along with tackling counterfeit goods. Other use cases can employ the teachings herein to support and track CITES permits through the U.S. Fish and Wildlife Service, evidence accreditation, evidence use of ethical materials, and ensure environmental and social compliance through tracking of activities by carbon neutral organizations, for example by validating ESG standards and supporting decarbonization audits, to name a few.

At the end of the typical retail chain, a first purchaser (404) may acquire the RWA (60) either in-store or online from the retailer (402). Upon acquisition of the RWA (60), the digital passport, which corresponds to a first pairing between the RWA (60) and an authentication mechanism (not shown in FIG. 7) and a second pairing between the first purchaser (404) and the RWA (60), is generated and can be downloaded to a digital Web3 wallet of the first purchaser (404). This can occur through a tokenization process that comprises part of a TaaS, and can lever smart contracts to verify custody chain data and compliance metrics. Tokenization can also enable fractional ownership and jurisdiction compliance tracking.

As previously discussed, the digital passport may be a QR code that is associated with the RWA (60) and enables the first purchaser (404) to access exclusive events and/or promotions associated with, for example, the manufacturer (400) of the RWA (60). The digital passport (e.g., QR code in a Web3 wallet) allows the first purchaser (404) to benefit from the investment made in the RWA (60) from both online and in-person events.

### Benefits of RWA Tokenization

Various benefits can be achieved by tokenizing RWAs. In this context, a token refers to a digital representation of ownership, rights or interest (e.g., financial interest) in an asset. One benefit of tokenizing RWAs is that tokenization can facilitate the dynamic creation of a structured financial product(s) and derivative(s) that are tied to the RWA. The term structured financial product encompasses any financial instrument, asset class, or investment vehicle derived from the digitization of an RWA. Utilizing smart contracts, this provides the capability to automate derivative products, create ESG-linked bonds and asset-backed securities, while all along insuring compliance with jurisdictional and risk management standards. This “On Chain Verification” or “OCV” can be tailored to align with the concerns of regulatory bodies, such as the CFTC, to achieve a compliant and standardized RWA tokenization market.

Tokenization also enables a secondary market to facilitate secured trading of tokenized RWAs and other structured and/or synthetic financial products. Synthetic financial instruments are derivative products which replicate the behavior of underlying assets without requiring direct ownership of those assets. Synthetic financial instruments are widely used by quant traders to manage risk, speculate, hedge positions and create arbitrage opportunities. Synthetic futures on Siberian crude oil is an example of a synthetic financial instrument. Currently, static contracts tied to specific grades fail to capture dynamic market shifts and there are no granular synthetic products for niche oil markets. With the present solution, synthetic futures can be tied to tokenized crude oil attributes (e.g., grade, location), and risk-adjusted alpha can be enabled by real-time quality adjustments.

It should be appreciated that these secondary markets can have various features such as cross-chain interoperability for trading across different blockchain ecosystems, atomic settlement for real-time trade finality, and compliance enforcement and programmable royalty distribution systems through the use of smart contracts.

Continuing with the above scenario, on the secondary market, for example, a second purchaser (406) can acquire the RWA (60) from the first purchaser (404). Upon verification of the acquisition of the RWA (60) by the second purchaser (406), the digital passport of the first purchaser (404) is revoked or deactivated. In an example, the revocation or deactivation can be performed by the described embodiments. Alternatively, the described embodiments can instruct third-party software to perform the revocation or deactivation procedures. A new digital passport is generated for the second purchaser (406) who is now the new owner of the RWA (60). Now, the second purchaser (406) can benefit from access to exclusive events and/or promotions associated with, for example, the manufacturer (400) of the RWA (60), whereas the first purchaser (404) is now restricted from these events due to his/her digital passport being revoked or deactivated (or voided).

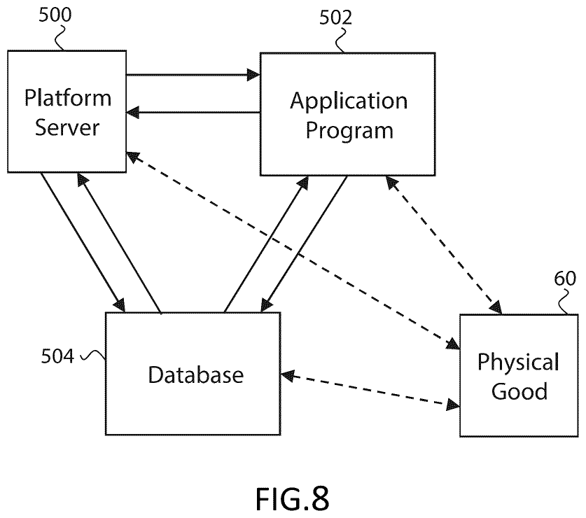

FIG. 8 is a schematic diagram illustrating the interactions between components of embodiments in accordance with the disclosed technology. As shown therein, an example system includes a platform server (500), an application program (502) that may be operating on a wireless device of the owner of the RWA or product (60), and a database (504) that stores information associated with the RWA (60). In an example, the platform server (500) is configured to perform the example method shown in FIG. 9 and described below. In another example, the database (504) corresponds to the public database (30) shown in FIG. 1 and FIG. 5. As previously discussed, the database stores information associated with the RWA (60). A first subset of the information can be stored on the authentication mechanism (e.g., an RFID tag or an NFC tag), and a second subset of the information can be stored in the digital passport. The database (504) being communicatively coupled to the platform server (500), which is associated with the blockchain platform, ensures that the information across the database (504), the authentication mechanism, and the digital passport remains consistent, traceable, and immutable. This ensures that any purchaser using the application program (502) and having verifiably acquired the RWA (60) will have access to the benefits that are associated with ownership of the RWA (60).

In some embodiments, the example system shown in FIG. 8 may be used in the transfer of raw materials from a first jurisdiction to a second jurisdiction in which the RWA is manufactured using the raw materials from the first jurisdiction. In other embodiments, the raw materials may be divided prior to only a portion being transferred to the second jurisdiction. In an example, an alligator hide ethically sourced in a first jurisdiction could be used to create a clutch purse (by a manufacturer in the second jurisdiction) and as part of an artwork (by the source in the first jurisdiction). Herein, the platform server (500) is configured to implement the method shown in FIG. 9B, wherein the platform server (500) generates two digital passports for the source, one for each portion of the alligator hide that will be used separately. The first digital passport, owned by the source, is sent to the manufacturer to provide to any border authorities to enable the importation of one portion of the alligator hide, whereas the second digital passport remains with the source (and corresponds to the portion of the alligator hide to be used to create the artwork). Once the manufacturer acquires their portion of the alligator hide, the first digital passport is revoked (or deactivated), and a new digital passport that corresponds to a pairing between the manufacturer and the ethically-sourced portion of the alligator hide to be used for the clutch purse is generated. Using the described embodiments automates the currently paper-based permitting process that is highly prone to manipulations and errors, and is subject to many drawbacks, e.g., fraud, counterfeiting, and long processing times.

FIG. 9 is a flowchart of an example method (600) for blockchain-based asset authentication. The method (600) includes, in an operation (602), performing a first pairing between a RWA and an authentication mechanism that uniquely identifies and stores a subset of the information.

The method (600) includes, in an operation (604), writing, using a first application programming interface (API), a transaction that is correlated with the first pairing to the blockchain platform. In this and other examples discussed herein, the platform server writes the transaction to the blockchain platform. Alternatively, in these examples, the platform server may instruct a third-party to write the transaction to the blockchain.

The method (600) includes, in an operation (606), receiving, from an application program using a second API different from the first API, a first message indicative of an owner acquiring the RWA (e.g., through a sale, exchange, or gift). In some embodiments, the application program is associated with the owner. In an example, the first API is the Polygon.io Crypto API and the second API is a third-party API that is compatible with the application program.

The method (600) includes, in an operation (608), generating, upon receipt on the first message and based on the first message and the information associated with the RWA, a digital passport. Herein, the digital passport corresponds to the first pairing and a second pairing between the owner and the RWA.

The method (600) includes, in an operation (610), writing, using the first API, another transaction that is correlated with the second pairing to the blockchain platform, with the second pairing being immutably linked to the first pairing.

In some embodiments, the method (600) includes the operation of receiving, by a platform server associated with a blockchain platform from a database, information associated with a RWA.

In some embodiments, the authentication mechanism is a Radio Frequency Identification (RFID) tag, a Near Field Communication (NFC) tag, or a holographic sticker that is affixed on outward facing packaging of the RWA, and wherein the authentication mechanism is configured to remain with the RWA through its lifecycle. In an example, the holographic sticker is created using an electron-beam lithography system, and wherein the holographic sticker displays indicia corresponding to a verification status as part of the authentication mechanism.

In some embodiments, the authentication mechanism is an image capture device (e.g., a cellphone camera, as implemented by Veracity Protocol™ for authentication). In an example, a vectorized or rasterized image of the RWA is generated as the authentication mechanism and can capture the specific variations of a particular copy of the RWA, i.e., any manufacturing variations in the luxury goods, which are typically handmade, will be preserved in the vectorized or rasterized image. This authentication information can be stored, in part or in full, in the database shown in FIGS. 1, 5 and 8, an authentication tag, and/or the digital passport. In other embodiments, the authentication mechanism is a secure hologram sticker (e.g., created with electron-beam lithography systems and displaying a verification status to verify its authenticity) that can be placed on outward facing packaging of the RWA.

In some embodiments, the application program is further configured to store the digital passport in a digital Web3 wallet.

In some embodiments, the platform server is further configured to create a digital representation of the RWA, and write, using the first API, yet another transaction that is correlated with a third pairing between the digital representation and the RWA to the blockchain platform. Herein, the third pairing is immutably linked to the first pairing and the second pairing, and the digital representation of the real-world asset (RWA) can be used exclusively by the owner in a metaverse. Herein, the owner is able to use the RWA as well as the digital representation, e.g., in Second Life™, any augmented reality (AR) or virtual reality (VR) platform, or metaverse by Facebook™.

In some embodiments, the digital representation of the RWA is a non-fungible token (NFT), or other digital token, such that the tokenization of the RWA via an NFT can be used to provide access to events, partnership promotions and cross-selling opportunities linked to the authenticated good. As is often the case with NFTs, the NFT for the RWA may have on-chain metadata that references certain characteristics of the NFT, such as current ownership, asset status, and transaction information. Additional information can be stored off-chain in an interplanetary file system (IPFS) or other appropriate storage locations.

In certain circumstances, though not by way of limitation, it is contemplated that the digital token can be fractionalized into multiple ownership units and that one or more smart contracts could be employed to govern the terms of ownership, fractionalizing and trading of the digital token amongst participants and stakeholders who can acquire such rights using stablecoins, fiat currencies, cryptocurrencies, digital currencies or other digital tokens, to name a few. Such participants may include, for example, suppliers, artisans, brands, purchasers, end users, or any other interested secondary market participants. Trading of the digital tokens (or their fractional ownership units) can occur on centralized or decentralized exchanges, or traded as derivatives in commodities markets, thereby leveraging free market economics. For certain types of goods, these same smart contracts (or others) can be used to automate the distribution of royalties and appreciation value to original creators, brands, and stakeholders upon each secondary sale of the fractional units, thereby creating brand equity through collective benefit and future appreciation. In another use case example, all or a portion of revenues from participation in secondary markets could be returned to original farmers and crop creators of commodities markets. It is contemplated that governance mechanisms, such as DAOs, custodians or smart contract, can be employed to determine the control, transferability and compliance verification of an asset and financial distributions pertaining to the same. Such a system incentivizes stakeholders to participate in the ecosystem by offering a potential upside to participation and transparency, thereby encouraging above-board behavior. In such a situation, it is contemplated that each valid stakeholder would have a respective digital passport reflecting his/her fractional ownership and, thus, entitlement to a downstream royalty. These digital passports would then be used as mechanisms to connect to the trading gains to and from the original consumer, collector or creator of the RWA. Tokens can thus be used to track ownership, royalties and provenance of collectibles and the digital product passports can be used to enhance provenance tracking and liquidity for RWAs, such as high-value collectables.

In some embodiments, the digital passport enables the owner to access a marketing event associated with a manufacturer of the RWA, a partnership promotion associated with other owners of other instances of the RWA, or a cross-selling event associated with manufacturers of other goods that are similar to the RWA.

In some embodiments, the RWA comprises a luxury good, a collectible, an artwork, or a product in a supply chain. In an example, the described embodiments are applied to luxury goods, artwork, collectibles, and/or memorabilia, which are typically manufactured in limited quantities. The authentication mechanism authenticates the provenance of these RWAs, and the digital passport enables verified owners of these RWAs to access exclusive events and partnership promotions. In another example, the described embodiments are applied to products (or raw materials, natural goods, or manufactured goods) in a supply chain. Here, the authentication mechanism authenticates the sourcing of the products to ensure that it is compliant with any jurisdictional requirements.

In some embodiments, the method (600) further includes the operation of sending the digital passport to an insurance coverage provider, which issues a policy covering the RWA against a loss due to theft or destruction of the RWA. Having access to the digital passport streamlines the insurance process for the insurance coverage provider because the provenance and sourcing of the RWA has already been verified in the digital passport, and the insurance coverage provider will not typically need any additional information. In still another embodiment, tokenization of the RWA can allow the token to be used as collateral for securing a loan. In still another embodiment, the method (600) further includes the operation of sending the digital passport to a financial institution, which provides a loan to the owner of the RWA secured by the RWA. These and other examples illustrate robust systems and methods for blockchain-based authentication, tokenization and securitization of real-world assets (RWAs).

In some embodiments, the at least one application program is further configured to transmit, to the at least one platform server using the second API, a second message indicative of a subsequent owner acquiring the RWA. Then, the at least one platform server is further configured to revoke or deactivate, upon receipt of the second message, the digital passport. Upon revoking or deactivating the digital passport, the at least one platform server generates, based on the second message and the information, a new digital passport corresponding to the first pairing and a third pairing between the subsequent owner and the RWA. The at least one platform server now writes, using the first API, yet another transaction that is correlated with the third pairing to the blockchain platform. Herein, a link between the second pairing and the first pairing is invalidated, and the third pairing is immutably linked to the first pairing. The new digital passport is finally transmitted to the subsequent owner. As previously discussed, this enables a subsequent owner to now access exclusive events and/or promotions associated with the RWA using the new digital passport. These benefits were previously accessible to the owner when he/she owned the RWA, but cannot be accessed now because the digital passport has been revoked or deactivated.

In some embodiments, the platform server is further configured to create a digital representation of the RWA, and write, using the first API, yet another transaction that is correlated with a fourth pairing between the digital representation and the RWA. Herein, the fourth pairing is immutably linked to the third pairing and the first pairing, and the digital representation can be used exclusively by the subsequent owner in a metaverse.

In some embodiments, the new digital passport enables the subsequent owner to access an event associated with a manufacturer of the RWA, but the owner is restricted from accessing the event due to the digital passport being revoked or deactivated.

In some embodiments, the information associated with the RWA comprises a product serial number, a product description, a manufacturing date, a proof of authenticity, and/or compliance information.

In some embodiments, the digital passport comprises a QR code, an encoded visual identifier, or a unique wireless signal. In other embodiments, the digital passport comprises a portion of the subset of the information associated with the RWA.

Embodiments of the disclosed technology further provide an example system for blockchain-based asset authentication. The system includes at least one platform server associated with a blockchain platform, at least one database configured to store information associated with a RWA, and at least one application program associated with an owner of the RWA. In this system, the at least one platform server configures a first pairing between the RWA and an authentication mechanism that uniquely identifies and stores a subset of the information, and then writes, using a first application programming interface (API), a transaction that is correlated with the first pairing to the blockchain platform. This is followed by the at least one application program transmitting, to the at least one platform server using a second API different from the first API, a first message indicative of the owner acquiring the RWA. Once the RWA has been purchased by the owner (e.g., either online or in-person), the at least one platform server receives, from the at least one application program using the second API, the first message. Upon receipt of the first message, the at least one platform server generates, based on the first message and the information associated with the RWA, a digital passport corresponding to the first pairing and a second pairing between the owner and the RWA. Then, another transaction that is correlated with the second pairing is written, using the first API, to the blockchain platform such that the second pairing is immutably linked to the first pairing.

In some embodiments, the blockchain platform comprises a public blockchain platform that uses a proof-of-stake consensus mechanism for processing on-chain transactions and a native token that is compatible with an ERC-20 token, e.g., Polygon™ blockchain platform, Hedera™, Ethereum™, or any other suitable public or private, proprietary or non-proprietary distributed ledger system or equivalent cryptographic system capable of recording and verifying asset-related transaction. The ordinarily skilled artisan will appreciate that the disclosed technology can utilize public blockchain architectures and protocols such as these, permissioned blockchain architectures and protocols, private blockchain architectures and protocols, or suitable combinations of these. Furthermore, while the technology leverages off-chain data storage techniques, it is contemplated that aspects of the teachings herein could benefit for on-chain data storage where possible, or combinations of on-chain and off-chain storage. On-chain storage may generally refer to a decentralized tamper-resistant data recording mechanism.

In some embodiments, the blockchain platform comprises a permissioned blockchain platform. In an example, using a permissioned blockchain enables the authenticity of a purchase of the RWA by the subsequent owner is based on a third-party validator or a gated NFT. In another example, the permissioned blockchain is configured to operate with each of the participants (e.g., the manufacturer, the retailer, the original and subsequent purchasers, and, if applicable, regulatory authorities or validators) who have their own credentials and blockchain permissions (e.g., read and/or write capabilities).

FIG. 9B is a flowchart of another example method (650) for blockchain-based asset authentication. The method (650) includes, in an operation (652), receiving, by at least one platform server from at least one database, information associated with a raw material for manufacturing a first RWA and a second RWA. Herein, the at least one platform server is associated with a blockchain platform and a plurality of smart contracts on the blockchain platform. In this example, the raw material is sourced in a first jurisdiction and the first and second RWAs are manufactured in a second jurisdiction different from the first jurisdiction. Furthermore, a first portion of the raw material is used to manufacture the first RWA and a second portion of the raw material is used to manufacture the second RWA.

The method (650) includes, in an operation (654), configuring a first pairing between the raw material and an authentication mechanism, and a second pairing between the raw material and a verification mechanism that verifies a sourcing of the raw material is compliant with applicable statutes of the first or second jurisdictions, and a compliance of the sourcing is associated with a sourcing identifier. Herein, the authentication mechanism uniquely identifies a source of the raw material and stores a subset of the information.

The method (650) includes, in an operation (656), writing a transaction that is correlated with the first pairing and the second pairing to the blockchain platform with the second pairing being immutably linked to the first pairing, and the transaction comprising the sourcing identifier. Herein, the transaction is written to the blockchain platform using a first application programming interface (API), e.g., the Polygon.io Crypto API for the Polygon™ blockchain platform.

The method (650) includes, in an operation (658), generating, by at least a first smart contract and upon detecting that the transaction has been written to the blockchain platform, a first digital passport and a second digital passport. Herein, the first digital passport corresponds to the first portion of the raw material, the first pairing, and the second pairing, and the second digital passport corresponds to the second portion of the raw material, the first pairing, and the second pairing.

The method (650) includes, in an operation (660), transmitting the first digital passport to the source of the raw material.

The method (650) includes, in an operation (662), transmitting the second digital passport and the sourcing identifier to an application program associated with a manufacturer of the second RWA.

In some embodiments, the method (650) further includes the application program being configured to transmit, upon receiving the second digital passport and the sourcing identifier, the second digital passport to a border authority of the second jurisdiction to enable import of the second portion of the raw material into the second jurisdiction. Then, the application program configures a third pairing between the second portion of the raw material and the manufacturer of the second RWA.

In some embodiments, the method (650) further includes the at least one platform server being configured, upon determining that the raw material has been physically acquired by the manufacturer, to revoke or deactivate the second digital passport by invalidating a link between the first pairing and the second pairing. Then, the at least one platform server writes another transaction correlated with the third pairing to the blockchain platform such that the third pairing is immutably linked to the second pairing. Finally, the at least one platform server generates a new digital passport corresponding to the second and third pairings, and transmits the new digital passport to the application program associated with the manufacturer of the second RWA.

In some embodiments, the first digital passport and the new digital passport are concurrently active and enable both the source and the manufacturer to access one or more events associated with the raw material and/or the first and second RWAs.

Embodiments of the disclosed technology further provide another example system for blockchain-based asset authentication. The system includes a processor of at least one platform server associated with a blockchain platform, and a non-transitory memory, coupled to the processor, having code stored thereon, the code, when executed by the processor, causing the processor to perform a series of operations. The operations include receiving, by the at least one platform server from at least one database, information associated with a RWA. The at least one platform server then configures a first pairing between the RWA and an authentication mechanism that uniquely identifies and stores a subset of the information, and writes, using a first application programming interface (API), a transaction that is correlated with the first pairing to the blockchain platform. Next, the at least one platform server receives, from at least one application program using a second API different from the first API, a first message indicative of an owner acquiring the RWA. Upon receipt of the first message, the at least one platform server generates, based on the first message and the information associated with the RWA, a digital passport corresponding to the first pairing and a second pairing between the owner and the RWA. Another transaction that is correlated with the second pairing is written, using the first API, to the blockchain platform, such that the second pairing is immutably linked to the first pairing.

In some embodiments, the blockchain platform comprises a blockchain platform that uses a proof-of-stake consensus mechanism for processing on-chain transactions, and a completion time of the proof-of-stake consensus mechanism is based on a number of threads supported by the processor.

With an appreciation of the above embodiments, the ordinarily skilled artisan will appreciate that artificial intelligence (AI), machine learning (ML) and internet of things (IoT) devices could be employed throughout the lifecycle of the good to form part of verification system discussed above. For example, a suitably configured camera can be used at different points along the lifecycle as needed to capture images of the physical item which can then be pre-processed (if desired) to enhancing its quality of the image(s), crop the image(s) and normalize the image(s) to condition them for use in the authentication system described herein. AI can then interact with the image(s), for example, through the use of Convolutional Neural Networks (CNNs) conduct image classification and feature extraction. It is also contemplated that other features such as You Only Look Once (YOLO), Faster R-CNN and RetinaNet could be employed to provide enhanced object detection. Suitable Optical Character Recognition (OCR) techniques can also be employed (as desired) to extract relevant text information from the images to be included, for example, as part of the metadata associated with the RWA's token. These visual features identified by an AI engine can be compared against known feature patterns maintained in a database or other storage location to validate/verify the authenticity of the item and prevent counterfeiting. These validation results can themselves also be stored on the blockchain.

ML can also be employed for determining intrinsic valuation of RWAs, for example, by making ML-based net operating income (NOI) predictions for Class A office buildings. There is currently a lack of dynamic adjustments for market factors such as tenant quality, lease changes, etc., and static evaluations fail to support real time trading decisions. ML can be used to adjust NOI predictions based on tenant data and market conditions, and tokens can dynamically reflect NOI changes, thus allowing institutional traders to justify alpha positions.

It should be appreciated too that the underlying RWA asset and its associated RWA token(s) can be dynamically linked or independent of one another. It is contemplated that dynamic linking can be accomplished via use of token metadata, smart contracts, hashing algorithms, block payloads (or combinations of any of these) to pair the RWA token with its associated RWA asset. Consider fractional NOI and equity tokens for real estate. A Class A office building could issue two types of tokens. NOI tokens would represent future cash flows (e.g., projected rental income), while equity tokens would represent ownership stakes in the building. Dynamic feed integration would enable the tokens to adjust based on NOI fluctuations due to tenant turnover or lease renewals, or property revaluation based on local market conditions. With the present solution, owners can leverage NOI tokens to secure debt financing tied to real-time cash flow projections, thereby enhancing liquidity. In general, real-time updates to dynamic feeds and metadata can be make based changes to the state of the RWA, market conditions or regulatory requirements, to name a few. Consider, for example, wheat futures that are priced dynamically based on satellite imagery data. Here, verified yield data can be used to inform tokenized futures, reducing risks for farmers and traders in volatile markets. Algorithmic trading can then be based on the direction of live markets feeds and timing.

Furthermore, the ability to connect/disconnect the underlying RWA allows for synthetic hedging strategies. Consider the following synthetic quant trade example involving an underlying asset in the form of a tokenized NOI-backed debt from the Class A office building. Suppose a trader's objective is to hedge against rising interest rates. A synthetic instrument is derived by creating a swap where fixed NOI cash flow is exchanged for variable-rate debt payments. This is then paired with a call option on a tokenized real estate index, hedging against potential appreciation in token prices. The following illustrative steps could be involved:
(1) analyze NOI-backed token's historical volatility and correlation with interest rate trends;
(2) use Monte Carlo simulations (which evaluate the impact of price volatility, supply-demand dynamics, and ESG compliance premiums on portfolio returns) to calculate the likelihood of NOI outperforming variable-rate debt payments under different rate environments; and
(3) execute the swap, locking in fixed payments while purchasing a call option on the index.

Thus, with the present solution, the RWA tokenization intrinsic valuation methodology allows hedge funds to take a position while reducing interest rate risk and maintaining upside exposure to real estate token appreciation.

Taking this a step further, the present solution can also be used to develop Quant trading models using statistical tools, such as Monte Carlo simulations or real-time feeds, whereby traders who calculate expected portfolio returns and VaR using simulations can now take positions on correlated RWA tokenization to assign portfolio weight of each tokenized commodity. It also allows quant traders to adjust their positions dynamically based on simulations tied to verified RWA attributes (e.g., purity of gold, oil grade). As an example, consider risk-neutral pricing for tokenized gold futures. Statistical techniques such as standard deviation and risk-neutral pricing ensure consistent valuation and seamless trading of tokenized gold futures across platforms. These models help quant traders assess price volatility, calculate hedging ratios, and simulate probabilistic outcomes, enabling optimized risk-adjusted positions. Real-time data feeds dynamically update prices, reflecting market sentiment and intrinsic value changes, thereby addressing inefficiencies and enhancing market participation.

Continuing with this example, the tokens could also be fractionalized. For example, a $10 million office building could be tokenized into $10,000 units. Investors, thus, gain fractional ownership of a high-value asset with improved liquidity. The prices of these fractionalized tokens can dynamically adjust based on local market conditions, real-time tenant occupancy data, etc. With the present solution, fractionalization democratizes access to institutional-grade assets, thus increasing market participation. Another related example is tokenizing and trading real estate investment trusts (REITs) based on NOI and market sentiment, wherein dynamic pricing and liquidity improve access to the institutional-grade real estate investments.

IoT devices can also be used through the lifecycle to track aspects of the RWA by capturing real-time custody and condition data. For example, at border authorities, ports of entry, point of sale locations and the like, cameras can be used to capture transfer of ownership transactions and record this information on the blockchain as a secondary source of proof the RWA has changed hands. Satellite imaging systems could also be employed to validate the physical presence and geolocation of the RWA. The IoT device(s), as well as the AI component(s) discussed above, can interact with the various smart contacts and other components of the blockchain-based authentication system to create and maintain a comprehensive and transparent immutable record of the provenance, verification, ownership, etc. of the RWA throughout its entire lifecycle.

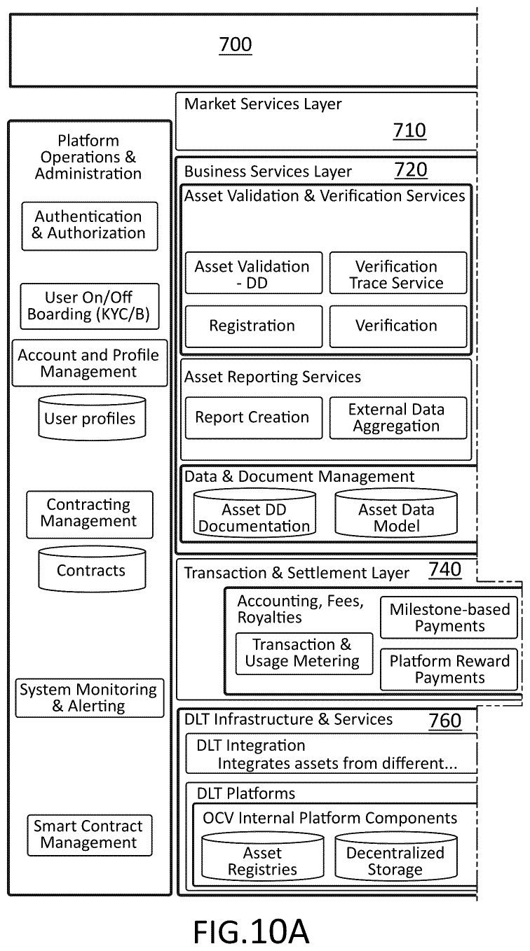

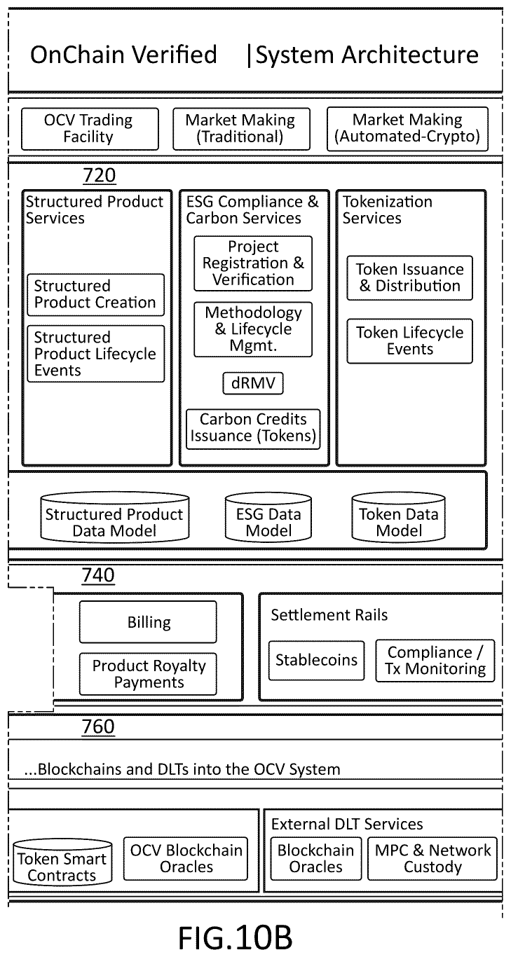

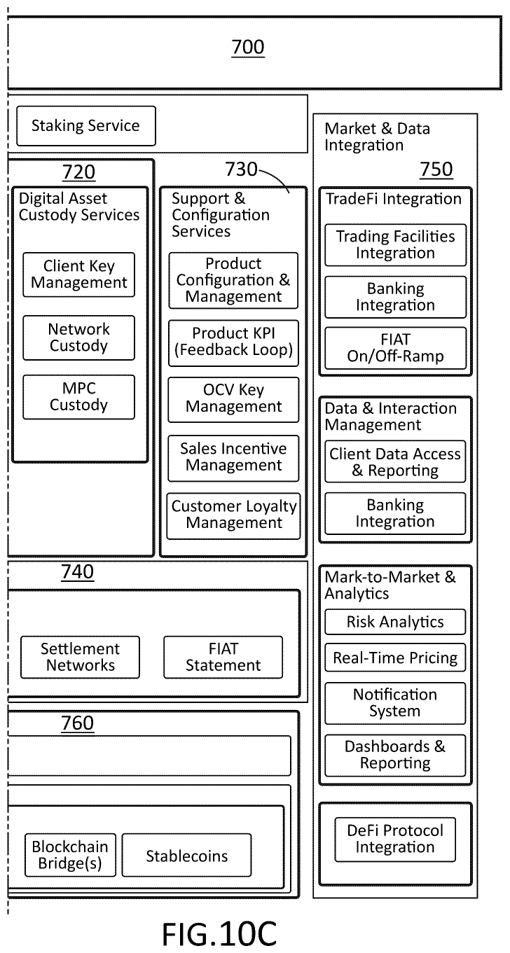

FIG. 10 illustrates a representative system architecture 700 for achieving one of more aspects of the disclosed technology. The various components for the system architecture depicted in FIG. 10 should be readily understood by the ordinarily skilled artisan and, therefore, need not be described in detail. That said, certain aspects are discussed.

System architecture 700 may accomplish at least the following core business capabilities:
1. Verification as a Service (Vaas): Real-time verification of assets, leveraging AI, IoT and decentralized oracles.
2. Tokenization as a Service (TasS): Creating fractional ownership through blockchain-based tokenization.
3. Structured Product Creation: Support for financial instruments (e.g., asset-back derivatives, ESG-linked bonds).
4. ESG Compliance Services: Automating compliance reporting and carbon credit management.
5. Trading Platform Integration: compatibility with institutional systems such as Bloomberg and CQG for real time trading and analytics

The key stakeholders/users of the platform include institutional investors, regulators, technology partners, asset owners, and trading platform operators.

The Market Services Layer 710 identifies the services (i.e., applications) that are provided to the market participants. The Business Services Layer 720 is the backbone of operational and administrative processes, supporting the platform's core business functionalities. It ensures seamless execution of essential business processes, compliance, and financial management. The Support and Configuration Services Layer 730 provides foundational tools and services to configure, manage, and maintain the platform's core functionalities. The Transaction and Settlement Layer 740 ensures that the secure, efficient and compliant execution of transactions and settlements across the platform. The Market and Data Integration layer 750 serves as the interface for aggregating, processing, and distributing external market data while ensuring seamless interoperability with external systems and trading platforms. This integration layer makes the platform's internal functions available to the broader traditional financial (TradFi) and decentralized finance (DeFi) ecosystems. DLT Infrastructure and Services 760 includes DLT Integration for integrating assets from different blockchains and DLTs into the On Chain Verified (OCV) system, and DLT Platforms which are the OCV components that run the DLT Platforms.

The data architecture for the system in FIG. 10 defines the structure of data assets and the data management resources. These may include the following core components:

### Data Models

Asset Data Model: Includes metadata for physical assets (e.g., real estate, commodities)—including provenance, ownership, and valuation.
Token Data Model: Digital representation of assets (e.g., ERC-20, ERC-721 standards).
ESG Data Model: Tracks carbon credits, compliance metrics, and sustainability data
Financial Product Data Model: Tracks all relevant information regarding the financial products.

### Data Sources

On-Chain Data: Blockchain-stored records for asset verification and tokenization.
Off-Chain Data: External data sources (e.g., IoT sensors, satellite imagery, financial databases).

### Data Governance

Compliance with data privacy regulations (GDPR, CCPA).
Ensuring data integrity and accuracy through blockchain notarization and timestamping.

### Data Integration:

Use of Oracles (e.g., Chainlink) for integrating off-chain data into smart contracts.
APIs for connecting with external systems (e.g., ESG data providers, financial databases).

The technology architecture for the system in FIG. 10 defines the infrastructure components for scalability, reliability and security. This may include the following core infrastructure:

### Blockchain Foundation

Hedera Hashgraph as the primary blockchain for tokenization and consensus.
Cross-chain bridges to Ethereum, DFINITY, and others for interoperability.

### Cloud-Agnostic Hosting

Deployment on AWS, Azure, or Google Cloud with containerization (Docker, Kubernetes).
Elastic scaling to handle market volatility.

### Security and Compliance

Data encryption (AES-256) and secure identity management (SSO, MFA).
Regular security audits and compliance certifications (SOC 2, ISO 27001).
Data Protection and GDPR

### Oracles and Data Feeds:

Use of Oracles (e.g., Chainlink) for integrating off-chain data into smart contracts.
APIs for connecting with external systems (e.g., ESG data providers, financial databases).

Operationally, the system architecture of FIG. 10 can be cloud agnostic and employ containerization and microservices. For example, it can use Dockers and Kubernetes to enable scalability and cross-cloud deployment (e.g., AWS, Azure, Google Cloud.). The system can be designed to have elastic scaling based on transaction volume, especially during high market volatility. It can also be designed to implement load balancing and self-healing mechanisms to maintain performance and availability.

The following are certain non-functional requirements (NFRs) and guiding principles for the system of FIG. 10 which may also be implemented:

### System NFRs

1. Data Consistency and Latency Requirements→Latency, scalability
   Ensure that data processing meets high-speed, low-latency standards, similar to Bloomberg's, for rapid decision-making.
2. Redundancy and Failover Mechanisms→Availability
   Implement redundant data sources and failover processes to ensure continuous data availability, crucial for institutional-grade operations.
3. Data Encryption→Security
   Encrypt data at rest and in transit (AES-256 or equivalent) to meet financial industry security standards.
4. Token Standards Compatibility→Driven by platforms
   Support for ERC-20, ERC-721, and other token standards, enabling integration with DeFi and institutional platforms
5. Modularity
   Support for ERC-20, ERC-721, and other token protocols
   Upgradeable Contracts
6. APIs
   External systems integrated into the platform should undergo due diligence of their API capabilities. Conversely, OCV should provide its functionality to external partners and systems vis APIs.
7. Third-Party Audits and Compliance Checks
   Regularly security audits should be conducted, along with penetration tests to meet compliance standards such as SOC 2, ISO 27001 and GDPR. The system can, thus, help ensure regulatory and contractual adherence of an asset during its lifecycle.

Finally, the system architecture of FIG. 10 can leverage various technology partners for various aspects of its implementations such as KYC/AML, fiat onramping, custody, oracles, IAM, visual AI engines and an ESG methodology framework.

Two representative use cases are now introduced which can utilize one or more aspects of the system architecture of FIG. 10.

### 1. OnChain Verified Institutional Real Estate Use Case

In order to provide verification of the RWA, in this case real estate, the real estate asset can undergo a comprehensive verification utilizing one or more various technologies. The title can be verified via integration with local government registries or third-party services. The location of the real estate can be confirmed via GPS and satellite imaging to identify a building's precise geolocation. IoT sensors or third-party inspections provide real time updates on the building's physical state, i.e., its condition. Historical and projected cash flows may be collected, verified and digitized for accuracy in order to obtain a reflection of net operating income (NOI). Tenant creditworthiness can be assessed utilizing data on tenant credit scores, payment history and lease agreements. The building's classification (e.g., Class A, B or C) can be assessed based on industry standards. Metrics, such as energy efficiency, carbon neutrality, and sustainability certifications (e.g., LEED) maybe collected and verified to assess ESG compliance. In a commercial real estate scenario, for example, a LEED certification may be desirable to ensure a building meets certain ESG-desirable criteria. Herein, a compliance of the sourcing is associated with a sourcing identifier. Current ESG compliance lacks dynamic valuation linkage, and investors struggle to quantify ESG premiums in financial models. With the present solution, dynamic token valuations can incorporate LEED certifications and carbon offsets, and these tokens can automatically adjust based on ESG compliance metrics, thus enabling ESG-linked bonds and ETFs. More generally, then, the present solution enables structured product rebalancing to allow for the dynamic rebalancing of investment vehicles (e.g., ETFs or synthetic baskets) to ensure broader control over financial instruments. One example includes an ESG-focused ETF with real-time carbon neutral updates in which the ETF pools tokenized commodities such as sustainably mined gold and ESG-certified crude oil. Standard deviation models help traders quantify the volatility of ESG compliance scores, enabling automated rebalancing. This can be used to solve for dynamic weight adjustment, for example, through the creation of an ESG compliance score for each token. With the present solution, ETFs can dynamically reflect ESG compliance changes, attracting investors focused on sustainability benchmarks.

Once the verified RWA has been generated, all of this relevant data may be aggregated and recorded in a digital passport for the asset, similar to the digital passport discussed above, thereby creating an immutable record on the blockchain.

Next, the verified attributes of the verified RWA are tokenized to create RWA token(s), each representing at least a portion of the intrinsic value of the property. Also as part of this process, smart contracts can be programmed with embedded compliance rules, royalty mechanisms and dynamic updates has any one or more of the attributes change. The tokens may then be registered on the blockchain, ensuring transparency, traceability and immutability. The ordinarily skilled artisan will appreciate that such smart contracts, in this scenario and certain others discussed herein, may refer to programmable execution mechanisms that automate compliance, settlements and financial distributions.

At this point, once the tokenized asset is in place, structured financial products may be created, optionally using digital smart contracts, which are derived from the RWA token(s). A structured financial product refers to any financial instrument, asset class, or investment vehicle derived from the digitization of RWA ownership. For example, debt instruments can be created whereby tokenized future cash flows based on NOI projections are issued as debt products. Continuing with the example of a building discussed earlier, if the building has $10 million of annual NOI, this could be used to issue tokens representing $1 million increments of future income streams for lending purposes. Equity tokens can also be created by fractionalized equity shares, thereby allowing investors to purchase ownership stakes in the property. The fractionalization of equity shares allows the property's equity to be broken into smaller, tradeable units. This opens the door for smaller investors to participate, improving market access and liquidity. That can then be issued against the property's tokenized NOI. For example, a property with verified $10 million NOI can issue a loan for $5 million backed by its tokenized future income streams. Real-time data can then be used to update the NOI token's value based on tenant payments, lease renewals, marketing conditions, or other relevant factors. This can result in an updated, subsequent intrinsic valuation for the RWA which can be reflected on the blockchain by issuing a new digital passport reflecting the same.

Once the tokens and financial products are created they may be listed on a secondary market platform and traded dynamically as debt and equity tokens based on real-time data feeds and investor demand. Smart contracts ensure the token value reflects changes in NOI, tenant quality or ESG compliance. Quant traders Can create derivative like options or futures on tokenized real estate as hedging instruments.

Various benefits can be realized by stakeholders through this OnChain Verified institutional real estate use case. For real estate owners, liquidity can be unlocked without needing to sell the entire property and they can monetize future income streams through NOI tokens. For investors, they are given access to fractionalized real estate investments with low entry points, and they benefit from real-time updates and transparent valuation metrics. Lenders benefit by issuing loans based on verified, tokenized cash flows rather than outdated appraisals, and regulators are provided increased transparency and traceability through blockchain-based compliance.

### 2. OnChain Verified Commodities Markets Use Case

Another illustrative use case of the various concepts described herein pertains to commodities markets. Here, the process of verifying the RWA preferably begins with a comprehensive verification of various commodity attributes to establish intrinsic value. These attributes might include physical attributes, custodial attributes, market readiness and/or ESG compliance. For example, a shipment of 1000 barrels of crude oil may be verified for volume, grade (e.g., WTI or Brent) and origin compliance, with all data recorded immutably on a private more public distributed ledger.

Once verified, the commodity is tokenized into digital assets, creating a bridge between the physical and digital markets. Tokenization of the commodity entails creation of tokens, each of which represents a specific unit of the commodity (e.g., one barrel of oil, on ton of wheat). Embedded metadata includes verified attributes such as ESG compliance and location. The token's intrinsic value may then be calculated using real-world metrics such as market price, ESG premiums, and/or adjustments for geographic risks or market volatility. Continuing with the example, for 1000 barrels of WTI crude oil, various tokens can be created, each representing 1 barrel. The intrinsic value can be derived using the current market price plus a premium for ESG compliance.

Once tokenized, commodities can be bought or sold with atomic settlement. Ownership transfer and payment can occur instantly on the blockchain, thus providing simultaneous execution and eliminating the need for intermediaries, such as clearinghouses or brokers, which reduces fees and delays. With reference again to the current example, a trader who purchases 100 barrels of tokenized oil directly from a producer can settle the trade automatically, thereby allowing the producer to instantly reinvest funds.

Commodities also enable advanced financial products on secondary markets such as futures contracts, options, swaps and ETFs. They also allow for the creation of granular micro markets based on unique commodity attributes which may include localized trading whereby commodities from specific regions or sources are traded as niche products. Further, dynamic valuation can be achieved through real time updates to reflect changes in supply, demand and market conditions. These secondary markets provide various benefits including liquidity creation, hedging opportunities, arbitrage and new revenue streams. Additionally, these new market opportunities provide speed and efficiency. In the current environment, manual settlement delays reduce market efficiency. The present technology, however, allows for atomic settlement to enable instant transaction so traders can take more positions.

Various benefits are also provided to stakeholders in this use case. For commodity producers, they have quicker access by tokenizing assets and can monetize ESG certifications for premium pricing. Traders are able to enter and exit their positions more quickly due to real time settlement and they can lower average derivatives for advanced strategies. Investors can participate in fractionalized commodity markets and have access to diversified portfolios through ETF's. Regulators are also benefited because they can better ensure compliance since immutable records are stored on the blockchain.

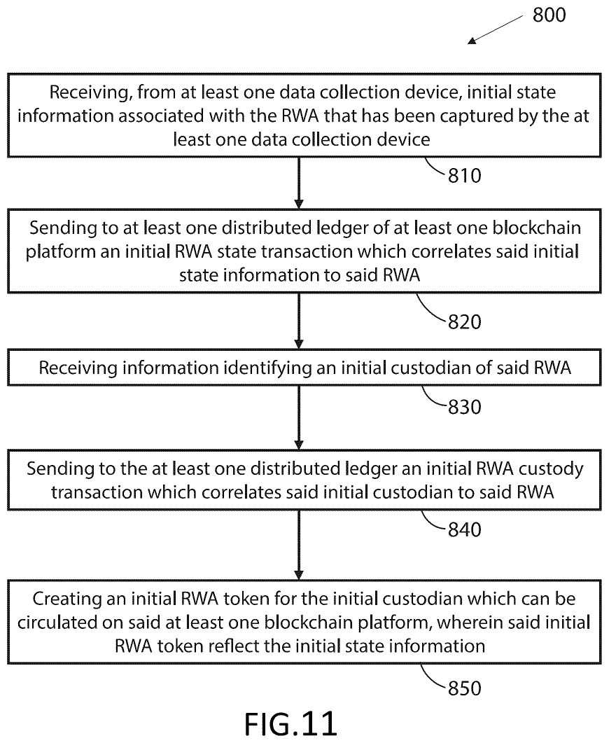

FIG. 11 is a flowchart 1100 of an example data management method for a real world asset (RWA), comprising:

At step 1110, receiving, from at least one data collection device, initial state information associated with the RWA that has been captured by the at least one data collection device. At step 1120, sending to at least one distributed ledger of at least one blockchain platform an initial RWA state transaction which correlates said initial state information to said RWA]. At step 1130, receiving information identifying an initial custodian of said RWA. At step 1140, sending to the at least one distributed ledger an initial RWA custody transaction which correlates said initial custodian to said RWA. And at step 1150, creating an initial RWA token for the initial custodian which can be circulated on said at least one blockchain platform, wherein said initial RWA token reflect the initial state information.

Lifecycle of a High-End Purse from Raw Materials to Finished Product and Beyond

With an appreciation of the above, the following description provides a representative example of a system for authenticating the validity and provenance of the components of, or finished product of, an existing or to-be-made physical RWAs. As discussed previously, the RWA may include real estate, consumer goods, collectibles (e.g. art, wine, and cars) to high-end luxury items such as jewelry, perfume, and clothing. In fact, the RWA many any asset that can benefit from the teachings herein. This specific example focuses on a purse throughout its lifecycle using the teachings herein including blockchain technology, smart contract(s), artificial intelligence (AI), and Internet of Things (IoT) devices. These physical components and finished real-world assets and their potential digital assets and derivatives, when registered to public or private blockchains, which may stay with the components or finished goods throughout the lifecycle and beyond, create a shared method and ecosystem for the mutual interests of transparency and integrity throughout the supply chain all the way to the end-users and beyond. This aligns interests for above-board compliance at the basic level, to exceeding expectations and excellence at the highest levels. This example is for illustrative purposes only and not by way of limitation.

The lifecycle of the high-end purse begins with the acquisition of raw materials such as leather or alligator skin. These materials are sourced from various suppliers and are subject to regulatory compliance checks. In some embodiments, each batch of raw material is assigned a unique digital passport recorded on the blockchain. This digital passport includes details such as source, quality certifications, and compliance with environmental regulations. IoT sensors (e.g., RFID tags, temperature, and humidity sensors) attached to the raw materials provide real-time data, ensuring the conditions meet the required standards during storage and transport. Smart contracts may be employed to automatically update the blockchain with this data, ensuring accurate and tamper-proof records.

AI-powered image capture devices at the supplier's facility record the condition and quality of the raw materials. Convolutional Neural Networks (CNNs) analyze images to detect defects or inconsistencies. Optical Character Recognition (OCR) techniques extract text information from certificates, such as regulatory agencies validating that the raw materials were sourced in compliance with international standards, and shipping documents, which is then recorded on the blockchain via smart contracts, automatically updating the digital passport.

The raw materials are exported to a jurisdiction where the manufacturing of the purse is completed. During this process, interactions with border authorities are recorded to ensure compliance with trade regulations. Export and import details, including border compliance checks and customs clearances, are updated on the blockchain. Smart contracts facilitate these updates by verifying compliance and automatically updating the digital passport. IoT devices such as GPS trackers monitor the location of shipments, while environmental sensors ensure conditions are maintained during transit. These devices interact with smart contracts to provide real-time updates to the blockchain.

Once the raw materials arrive at the manufacturing facility, the production of the purse begins. The manufacturing process involves multiple stages, including cutting, stitching, assembling, and quality control. In some aspects of the technology, AI algorithms such as Faster R-CNN and YOLO (You Only Look Once) are employed to monitor the manufacturing process. Image capture devices record each stage, and AI models analyze these images to ensure the manufacturing steps adhere to predefined standards. Anomalies or deviations are flagged for further inspection. Smart contracts may be used to log each completed stage on the blockchain, updating the digital passport. IoT devices also track various parameters (e.g., temperature, humidity) within the manufacturing environment to ensure compliance with regulations. This data is continuously recorded on the blockchain through smart contract interactions, updating the digital passport with compliance verification.

To further authenticate the purse, an RFID, a holographic sticker or another form of authentication mechanism, as discussed previously herein, is attached. This sticker remains with the purse throughout its lifecycle. The holographic sticker is scanned using appropriate scanning devices, creating a digital pairing between the sticker and the purse. This pairing is recorded on the blockchain via smart contracts, ensuring the authenticity of the item. The digital passport is updated to include this pairing information. The finished purse is then distributed to a retailer. Each transfer of ownership, from manufacturer to distributor to retailer, is recorded on the blockchain with the appropriate digital passports updated accordingly as discussed herein.

In some embodiments, at each point of sale, image capture devices record transactions. AI-powered facial recognition technology can be used to verify the identities of buyers and sellers, ensuring the legitimacy of transactions. Images of the purse are captured and compared to stored feature sets using RetinaNet to verify authenticity. Smart contracts facilitate the transfer of ownership by updating the digital passport with new owner information. For example, if the purse is purchased by the first end user (customer) the transaction details, including the buyer's information and purchase receipt, are recorded on the blockchain. If the purse is resold, subsequent transaction is similarly recorded. AI continues to play a role in verifying transactions through facial recognition and image analysis. IoT devices ensure that the physical conditions of the purse remain consistent with the recorded data. Smart contracts facilitate the transfer and update of the digital passport, ensuring continuous provenance tracking. AI models can be employed to analyze purchase receipts and shipping documents using OCR to extract and verify text information. These details are recorded on the blockchain via smart contracts, ensuring a continuous chain of custody. The digital passport is updated or replaced as ownership changes.

As discussed above, a digital twin of the purse can be created, for example, using digital representation derived from a smart contract, which may include a non-fungible token, a fungible token, or any other digital asset standard and can be utilized as a, or transformed into, a deposit token for decentralized finance operations. This tokenized version of the real-world asset can be marketed in secondary markets such as the metaverse or traded in digital marketplaces. In some aspects, the digital copy is minted as an NFT, with its unique attributes and provenance recorded on the blockchain. Smart contracts manage the creation and trading of the NFT, ensuring the digital representation is as authenticated and traceable as the physical item. The purse and its digital counterpart (NFT) can be traded in secondary markets, either together or separately. Each transaction, whether physical or digital, is recorded on the blockchain, maintaining the integrity of the provenance information.

With an appreciation of the above, it should be understood that the features described herein can be implemented to further provide one or more of the following representative technical solutions:

### 1. Authentication and Ownership

The disclosed technology provides systems and methods to authenticate and verify the ownership of real-world assets (RWAs). This is achieved using a multi-layered verification approach that may include:
IoT Sensors: Deployed to capture real-time data on the condition, provenance, and custody of the asset.
Satellite Imaging: Utilized for geographic and environmental verification, particularly for high-value commodities like rare earth metals or agricultural assets.
Manual Verification Processes: In scenarios where IoT or advanced technologies are unavailable, manual verification is incorporated, ensuring robust authentication in all environments.
Blockchain Storage: The authenticated data is recorded immutably on a blockchain, ensuring traceability, compliance, and transparency.

### 2. Tokenization and Intrinsic Value Creation

Verified RWAs are transformed into tokenized representations that encode intrinsic value attributes. These attributes may include:
Geographic Location
ESG Certifications
Market Demand
Physical and Economic Characteristics of the RWA

Further, the tokenization process may support the following: (1) Fractional Ownership, allowing assets to be divided into smaller units for increased accessibility and liquidity; (2) Programmable Royalties, ensuring that original creators, producers, or supply chain participants receive equitable distributions from primary and secondary market activities; and (3) Compliance Tracking, whereby tokens are dynamically updated to reflect jurisdictional regulations and market conditions.

### 3. Lifecycle Management and Supply Chain Applications

RWAs can be tracked through their lifecycle, from raw materials to finished products:
Raw Material Tracking: For example, agricultural commodities like organic corn can be tracked from planting to harvest, ensuring transparency and certification compliance.
Digital Passports: Each tokenized RWA is assigned a digital passport that logs all lifecycle events, including sourcing, processing, and end-use.
Transparent Supply Chains: Blockchain-based tracking ensures immutable and traceable records for improved accountability across industries.

### 4. Structured Financial Product Origination

Tokenized RWAs serve as the basis for a new class of structured financial instruments, including:
Derivatives (e.g., futures, options, swaps): Tied to the intrinsic value of tokenized commodities, real estate, or other RWAs.
Digital Asset-Backed Securities (DABSs): Offering an entirely new asset class for institutional and retail investors.
ESG-Linked Bonds: Backed by tokenized assets meeting environmental, social, and governance standards.
Pooled ETFs and Indices: Combining diverse tokenized assets into tradable financial products.

Further, these financial products automate risk management, compliance processes and settlement mechanisms.

### 5. Secondary Market Trading and Gains Distribution

The disclosed system facilitates efficient secondary market trading of tokenized assets through:
Atomic Settlement: Reducing counterparty risk and settlement delays.
Cross-Chain Interoperability: Enabling seamless trading across public, private, and hybrid blockchain ecosystems.
Programmable Royalties and Gains Distribution: Smart contracts dynamically distribute royalties and gains to stakeholders, including farmers, building owners, and creators.

In addition, AI models can integrated into trading mechanisms, enabling dynamic rebalancing of token attributes based on market conditions.

### 6. Sustainability and ESG Integration

The disclosed technology enables tokenization of assets that support environmental and sustainability goals:
Carbon Credits: Tokens reflect measurable carbon offset metrics, incentivizing investments in renewable energy and decarbonization projects.
Dynamic ESG Metrics: Tokens automatically adjust their valuations based on compliance with evolving ESG standards.
Sustainability Reportin: Blockchain-based systems ensure transparent reporting for investors and regulators.

### 7. Government Infrastructure and Public Projects

The disclosed technology can be extended to tokenizing government infrastructure and public assets, enabling:
Tokenized Municipal Bonds: Used to fund projects like roads, bridges, and renewable energy facilities.
Public Project Transparency: Blockchain ensures full accountability in capital raising and project execution.
Automated Compliance: Smart contracts enforce compliance with legal and regulatory requirements.

### 8. Synthetic Financial Products and Quant Trading Models

The disclosed technology supports advanced financial modeling for synthetic products, including:
Synthetic Futures and Swaps: Cash-settled instruments tied to tokenized commodities or real estate.
Monte Carlo Simulations: Used to optimize portfolio allocations and calculate risk-adjusted alpha.
Dynamic Portfolio Rebalancing: ETFs and indices automatically adjust based on updated token valuations.

An example use case for this is a synthetic swap for tokenized crude oil which adjusts dynamically based on satellite-imaged data and IoT-driven market conditions.

### 9. Dynamic Tokenization and Dual-Path Functionality

Tokens may be designed to:
Dynamically Reflect RWA Attributes: Such as changes in NOI for real estate or purity levels for commodities.
Support Decoupling from Underlying RWAs: Allowing synthetic hedging strategies while maintaining liquidity.

### 10. Off-Planet and Non-Traditional RWAs

The system accommodates tokenization of:
Asteroid-Mined Metals: Includes platinum-group metals, rare earth elements, and helium-3.
Solar Energy from Space: Tokenized representations tied to space-based renewable energy production.
Dynamic Valuation Models: Extraterrestrial tokens adjust based on metrics like extraction efficiency and market demand.

Embodiments for this may include:

Example 1: A digital passport dynamically updates ESG compliance metrics for a LEED-certified building, reflecting changes in carbon offsets and energy efficiency.

Example 2: Municipal bonds for solar energy projects are tokenized, enabling investor participation with automated compliance reporting.

Example 3: Tokenized wheat futures enable farmers to hedge against market volatility using IoT-driven yield data.

Example 4: NOI and equity tokens for Class A office buildings adjust dynamically based on tenant metrics and local market conditions.

The described features can also be implemented to further provide one or more of the following representative technical solutions:

### 1. A System for Custody Chain and Verification of RWAs:

A system for managing and verifying the custody chain of RWAs, comprising:
(a) one or more IoT devices, satellite imaging, and AI systems for capturing and authenticating custody chain data;
(b) a blockchain ledger for immutably storing ownership, condition, and location changes; and
(c) one or more smart contracts for validating compliance and updating tokenized representations, wherein the custody chain establishes intrinsic value and compliance for tokenized RWAs.

### 2. A Method for Tokenization of Verified RWAs:

A method for creating tokenized representations of RWAs, comprising:
(a) generating digital tokens based on verified custody chain data and compliance metrics;
(b) embedding programmable royalties and fractional ownership rights into smart contracts associated with tokenized RWAs; and
(c) writing tokens onto a blockchain platform for trading of structured financial products, wherein tokenized assets derive value from am RWA verification system.

### 3. System for Structured Financial Product Origination:

A system for automating structured financial products, comprising:
(a) one or more smart contracts for creating derivatives, ESG-linked bonds, and asset-backed securities; and
(b) mechanisms for integrating compliance, risk management, and settlement into product creation, wherein financial products rely on verified RWAs for collateral and compliance.

### 4. System for Secondary Market Trading of Tokenized RWAs:

A platform for trading tokenized RWAs, comprising:
(a) atomic settlement protocols for real-time execution;
(b) cross-chain interoperability for blockchain-based trading; and.
(c) custody chain validation for asset authenticity and compliance, wherein secondary markets depend on the intrinsic value and compliance established by the verification system.

### 5. System for Programmable Royalty Distribution:

A system for automating royalty distribution for tokenized RWAs, comprising:
(a) one or more smart contracts for allocating royalties based on market activity.
(b) at least one digital wallet for real-time payment in fiat or tokenized formats; and
(c) mechanisms for linking royalties to custody chain and compliance data.

### 6. System for ESG and Carbon Credit Integration:

A system for tokenizing carbon credits, comprising:
(a) mechanisms for validating offsets using IoT, satellite imaging, and compliance data; and
(b) one or more smart contracts for creating ESG-linked financial products and tax credit optimization.

### 7. Licensable Modular Framework for RWA Tokenization:

A modular framework comprising independently operable components for verification, tokenization, and financial product origination.

Additionally, one or more of the following features could be integrated into each of the above aspects, as desired:
(a). Custody Chain Integration with Financial Products to validates collateral and compliance for structured financial products;
(b) Atomic Settlement and Royalty Enforcement to ensures royalties are distributed upon trade execution;
(c) Cross-Chain Interoperability for Market Access to support interoperability for institutional adoption; and.
(d) Compliance-Driven ESG Metrics to automate ESG reporting and sustainability tracking.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of at least some of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

With the above description in mind, in some aspects, the techniques described herein relate to a data management system for a real world asset (RWA), including: at least one computing device associated with at least one blockchain platform, said at least one computing device having on-chain storage for maintaining a local copy of at least one distributed ledger that records transactions relating to said RWA; and at least one application program associated with the at least one blockchain platform, said at least one application program configured to: receive initial state information associated with the RWA that has been captured by at least one data collection device; record on the at least one distributed ledger an initial RWA state transaction which correlates said initial state information to said RWA; receive information identifying an initial custodian of said RWA; record on the at least one distributed ledger an initial RWA custody transaction which correlates said initial custodian to said RWA; and create an initial RWA token for the initial custodian which can be circulated on said at least one blockchain platform, wherein said initial RWA token reflects the initial state information.

In some aspects, the techniques described herein relate to a data management system wherein said at least one application program is further configured to create a structured financial product that is derived from said RWA.

In some aspects, the techniques described herein relate to a data management system wherein said structured financial product is one of a derivative, an ESG-linked bonds, a digital asset backed security (DABS), or a pooled ETF.

In some aspects, the techniques described herein relate to a data management system wherein said initial RWA token is dynamically connected to said RWA.

In some aspects, the techniques described herein relate to a data management system wherein said initial RWA token is disconnected from said RWA.

In some aspects, the techniques described herein relate to a data management system wherein said at least one application program is further configured to create an initial digital passport for display on a user device, wherein said initial digital passport verifies the initial custodian of said RWA and said initial state information.

In some aspects, the techniques described herein relate to a data management system wherein said initial state information corresponds to at least one of a condition of said RWA or a location of said RWA.

In some aspects, the techniques described herein relate to a data management system wherein said at least one application program is further configured to receive, from the at least one data collection device, subsequent state information associated with said RWA, and record on the at least one distributed ledger a subsequent RWA state transaction which correlates said subsequent state information to said RWA.

In some aspects, the techniques described herein relate to a data management system wherein said subsequent state information corresponds to at least one of a change in condition of said RWA or a change in location of said RWA.

In some aspects, the techniques described herein relate to a data management system wherein said at least one application program is further configured to receive information corresponding to a subsequent custodian of said RWA and record on the at least one distributed ledger a subsequent custody transaction which correlates said subsequent custodian to said RWA.

In some aspects, the techniques described herein relate to a data management system wherein said at least one application program is further configured create a subsequent RWA token for circulation on said at least one blockchain platform, wherein said subsequent RWA token reflects the subsequent state information.

In some aspects, the techniques described herein relate to a data management system wherein said at least one application program is further configured to selectively decommission said initial RWA token.

In some aspects, the techniques described herein relate to a data management system wherein said at least one application program is further configured to receive information corresponding to a subsequent custodian of said RWA and record on the at least one distributed ledger a subsequent custody transaction which correlates said subsequent custodian to said RWA.

In some aspects, the techniques described herein relate to a data management system wherein said at least one application program is further configured to interact with one or more smart contracts on the at least one blockchain platform to periodically validate regulatory compliance of said RWA, update said initial RWA token, and control circulation of said initial RWA token based on jurisdictional or contractual criteria.

In some aspects, the techniques described herein relate to a data management system wherein said at least one application program is further configured to interact with one or more smart contracts on the at least one blockchain platform to distribute a programmable royalty to an original owner of said RWA in response to a transfer of ownership of said initial RWA token.

In some aspects, the techniques described herein relate to a data management system wherein said at least one application program is further configured to interact with said one or more smart contracts to distribute a respective programmable royalty to the original owner of said RWA in response to a transfer of ownership of each subsequent RWA token.

In some aspects, the techniques described herein relate to a data management system wherein said at least one application program is further configured to interact with one or more smart contracts on the at least one blockchain platform to fractionalize ownership rights in said initial RWA token.

In some aspects, the techniques described herein relate to a data management system wherein said at least one application program is further configured to interact with one or more smart contracts on the at least one blockchain platform to link ESG metrics to said initial RWA token.

In some aspects, the techniques described herein relate to a data management system wherein said initial RWA token is configured for cross-chain circulation among multiple blockchain platforms.

In some aspects, the techniques described herein relate to a data management system further including at least one off-chain storage device for storing additional information associated with said RWA.

In some aspects, the techniques described herein relate to a data management system wherein the initial state information corresponds to at least one of an initial physical condition of said RWA, an initial geolocation of said RWA, and an initial compliance status of said RWA.

In some aspects, the techniques described herein relate to a data management system for a real world asset (RWA), including: at least one data collection device for capturing initial state information associated with the RWA; at least one computing device associated with at least one blockchain platform, said at least one computing device having on-chain storage for maintaining a local copy of at least one distributed ledger that records transactions relating to said RWA; at least one user device; and at least one application program associated with the at least one blockchain platform, said at least one application program configured, in conjunction with said at least one data collection device, said at least one computing device and said at least one user device, to: receive the initial state information from said at least one data collection device; record on the at least one distributed ledger an initial RWA state transaction which correlates said initial state information to said RWA; receive information identifying an initial custodian of said RWA; record on the at least one distributed ledger an initial RWA custody transaction which correlates said initial custodian to said RWA; and create an initial RWA token for circulation on said at least one blockchain platform.

In some aspects, the techniques described herein relate to a data management system wherein said at least one data collection device is configured to capture initial state information corresponding to at least one of an initial physical condition of said RWA, an initial geolocation of said RWA and an initial compliance status of said RWA.

In some aspects, the techniques described herein relate to a data management system wherein said at least one data collection device includes at least one of an IoT device, an imaging device and an AI device.

In some aspects, the techniques described herein relate to a data management system wherein said at least one application program is further configured to create a structured financial product that is derived from said RWA.

In some aspects, the techniques described herein relate to a data management system wherein said structured financial product is one of a derivative, an ESG-linked bonds, a digital asset backed security (DABS), or a pooled ETF.

In some aspects, the techniques described herein relate to a data management system wherein said initial RWA token is dynamically connected to said RWA.

In some aspects, the techniques described herein relate to a data management system wherein said initial RWA token is disconnected from said RWA.

In some aspects, the techniques described herein relate to a data management method for a real world asset (RWA), including: receiving, from at least one data collection device, initial state information associated with the RWA that has been captured by the at least one data collection device; sending to at least one distributed ledger of at least one blockchain platform an initial RWA state transaction which correlates said initial state information to said RWA; receiving information identifying an initial custodian of said RWA; sending to the at least one distributed ledger an initial RWA custody transaction which correlates said initial custodian to said RWA; and creating an initial RWA token for the initial custodian which can be circulated on said at least one blockchain platform, wherein said initial RWA token reflect the initial state information.

In some aspects, the techniques described herein relate to a data management method further including creating an initial digital passport for display on a user device, wherein said initial digital passport verifies the initial custodian of said RWA and said initial state information.

In some aspects, the techniques described herein relate to a data management method further including receiving from the at least one data collection device, subsequent state information associated with said RWA, and sending to the at least one distributed ledger a subsequent RWA state transaction which correlates said subsequent state information to said RWA.

In some aspects, the techniques described herein relate to a data management method further including receiving information corresponding to a subsequent custodian of said RWA and sending to the at least one distributed ledger a subsequent custody transaction which correlates said subsequent custodian to said RWA.

In some aspects, the techniques described herein relate to a data management method further including creating a subsequent RWA token for circulation on said at least one blockchain platform, wherein said subsequent RWA token reflects the subsequent state information.

In some aspects, the techniques described herein relate to a data management method further including selectively decommission said initial RWA token.

In some aspects, the techniques described herein relate to a data management method further including interacting with one or more smart contracts on the at least one blockchain platform to periodically validate regulatory compliance of said RWA, update said initial RWA token, and control circulation of said initial RWA token based on jurisdictional or contractual criteria.

In some aspects, the techniques described herein relate to a data management method further including interacting with one or more smart contracts on the at least one blockchain platform to distribute a programmable royalty to an original owner of said RWA in response to a transfer of ownership of said initial RWA token.

In some aspects, the techniques described herein relate to a data management method further including interacting with said one or more smart contracts to distribute a respective programmable royalty to the original owner of said RWA in response to a transfer of ownership of each subsequent RWA token.

In some aspects, the techniques described herein relate to a data management method further including interacting with one or more smart contracts on the at least one blockchain platform to fractionalize ownership rights in said initial RWA token.

In some aspects, the techniques described herein relate to a data management method further including creating a structured financial product that is derived from said RWA.

In some aspects, the techniques described herein relate to a data management method wherein said structured financial product is one of a derivative, an ESG-linked bonds, a digital asset backed security (DABS), or a pooled ETF.

In some aspects, the techniques described herein relate to a data management method wherein said initial RWA token is dynamically connected to said RWA.

In some aspects, the techniques described herein relate to a data management method wherein said initial RWA token is disconnected from said RWA.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements, and variations can be made based on what is described and illustrated in this patent document.

What is claimed is:

1. A data management system for a real-world asset (RWA), comprising:
at least one computing device associated with at least one blockchain platform, said at least one computing device having on-chain storage for maintaining a local copy of at least one distributed ledger that records transactions relating to said RWA; and
at least one application program associated with the at least one blockchain platform, said at least one application program configured to:
receive initial state information associated with the RWA that has been captured by at least one data collection device;
record on the at least one distributed ledger an initial RWA state transaction which correlates said initial state information to said RWA;
receive information identifying an initial custodian of said RWA;
record on the at least one distributed ledger an initial RWA custody transaction which correlates said initial custodian to said RWA; and
create an initial RWA token for the initial custodian which can be circulated on said at least one blockchain platform, wherein said initial RWA token reflects the initial state information.

2. The data management system of claim 1 further comprising a structured financial product that is derived from said RWA.

3. The data management system of claim 2 wherein said structured financial product is one of a derivative, an ESG-linked bonds, a digital asset backed security (DABS), or a pooled ETF.

4. The data management system of claim 1 wherein said initial RWA token is dynamically linked to said RWA.

5. The data management system of claim 1 wherein said initial state information corresponds to at least one of a condition of said RWA or a location of said RWA.

6. The data management system of claim 1 wherein said at least one application program is further configured to receive from the at least one data collection device subsequent state information associated with said RWA, and record on the at least one distributed ledger a subsequent RWA state transaction which correlates said subsequent state information to said RWA.

7. The data management system of claim 6 wherein said subsequent state information corresponds to at least one of a change in condition of said RWA or a change in location of said RWA.

8. The data management system of claim 7 wherein said at least one application program is further configured to receive information corresponding to a subsequent custodian of said RWA and record on the at least one distributed ledger a subsequent custody transaction which correlates said subsequent custodian to said RWA.

9. The data management system of claim 6 wherein said at least one application program is further configured create a subsequent RWA token for circulation on said at least one blockchain platform, wherein said subsequent RWA token reflects the subsequent state information.

10. The data management system of claim 9 wherein said at least one application program is further configured to selectively decommission said initial RWA token.

11. The data management system of claim 1 wherein said at least one application program is further configured to receive information corresponding to a subsequent custodian of said RWA and record on the at least one distributed ledger a subsequent custody transaction which correlates said subsequent custodian to said RWA.

12. The data management system of claim 1 wherein said at least one application program is further configured to interact with one or more smart contracts on the at least one blockchain platform to distribute a programmable royalty to an original owner of said RWA in response to a transfer of ownership of said initial RWA token.

13. The data management system of claim 1 wherein said at least one application program is further configured to interact with one or more smart contracts on the at least one blockchain platform to fractionalize ownership rights in said initial RWA token.

14. The data management system of claim 1 wherein the initial state information corresponds to at least one of an initial physical condition of said RWA, an initial geolocation of said RWA, and an initial compliance status of said RWA.

15. A data management system for a real-world asset (RWA), comprising:
at least one data collection device for capturing initial state information associated with the RWA;
at least one computing device associated with at least one blockchain platform, said at least one computing device having on-chain storage for maintaining a local copy of at least one distributed ledger that records transactions relating to said RWA;
at least one user device; and
at least one application program associated with the at least one blockchain platform, said at least one application program configured, in conjunction with said at least one data collection device, said at least one computing device and said at least one user device, to:
receive the initial state information from said at least one data collection device;
record on the at least one distributed ledger an initial RWA state transaction which correlates said initial state information to said RWA;
receive information identifying an initial custodian of said RWA;
record on the at least one distributed ledger an initial RWA custody transaction which correlates said initial custodian to said RWA; and
create an initial RWA token for circulation on said at least one blockchain platform.

16. The data management system of claim 15 wherein said at least one data collection device is configured to capture initial state information corresponding to at least one of an initial physical condition of said RWA, an initial geolocation of said RWA and an initial compliance status of said RWA.

17. The data management system of claim 15 further comprising a structured financial product that is derived from said RWA.

18. The data management system of claim 15 wherein said initial RWA token is dynamically linked to said RWA.

19. A data management method for a real-world asset (RWA), comprising:
receiving, from at least one data collection device, initial state information associated with the RWA that has been captured by the at least one data collection device;
sending to at least one distributed ledger of at least one blockchain platform an initial RWA state transaction which correlates said initial state information to said RWA;
receiving information identifying an initial custodian of said RWA;
sending to the at least one distributed ledger an initial RWA custody transaction which correlates said initial custodian to said RWA; and
creating an initial RWA token for the initial custodian which can be circulated on said at least one blockchain platform, wherein said initial RWA token reflect the initial state information.

20. The data management method of claim 19 further comprising creating an initial digital passport for display on a user device, wherein said initial digital passport verifies the initial custodian of said RWA and said initial state information.

21. The data management method of claim 19 further comprising receiving from the at least one data collection device, subsequent state information associated with said RWA, and sending to the at least one distributed ledger a subsequent RWA state transaction which correlates said subsequent state information to said RWA.

22. The data management method of claim 21 further comprising receiving information corresponding to a subsequent custodian of said RWA and sending to the at least one distributed ledger a subsequent custody transaction which correlates said subsequent custodian to said RWA.

23. The data management method of claim 22 further comprising creating a subsequent RWA token for circulation on said at least one blockchain platform, wherein said subsequent RWA token reflects the subsequent state information.

24. The data management method of claim 23 further comprising selectively decommissioning said initial RWA token.

25. The data management method of claim 19 further comprising interacting with one or more smart contracts on the at least one blockchain platform to fractionalize ownership rights in said initial RWA token.

26. The data management method of claim 19 wherein said initial RWA token is dynamically connected to said RWA.

27. A data management method for a real-world asset (RWA), comprising:
verifying the RWA, based on at least one attribute of the RWA, to generate a verified RWA;
creating at least one RWA token derived from the verified RWA, wherein each RWA token is representative of at least a portion of an intrinsic value of the RWA; and
registering each RWA token on at least one blockchain.

28. The data management method of claim 27 further comprising creating at least one structured financial product that is derived from the at least one RWA token.

29. The data management method of claim 27 further comprising creating an initial digital passport for display on a user device, wherein said initial digital passport verifies the initial custodian of said RWA, and writing to said at least one blockchain an initial custody transaction which correlates said initial custodian to said RWA.

30. The data management method of claim 29 further comprising receiving information corresponding to a subsequent custodian of said RWA and writing to the at least one blockchain a subsequent custody transaction which correlates said subsequent custodian to said RWA.
